(19) United States
(12) Patent Application Publication
(10) Pub. No.: US 2026/0087106 A1
(43) Pub. Date: Mar. 26, 2026

(54) SAVING A FILE USING A WATERMARK

(71) Applicant: COMPUGROUP MEDICAL SOFTWARE GMBH, Koblenz (DE)

(72) Inventor: Herrn Werner RODORFF, Bensheim (DE)

(21) Appl. No.: 19/338,455

(22) Filed: Sep. 24, 2025

(30) Foreign Application Priority Data
Sep. 24, 2024 (EP) 24202084.0

(51) Int. Cl. G06F 21/16

(52) U.S. Cl. CPC G06F 21/16

(57) ABSTRACT

Disclosed is a computer-implemented method for securing a file using a digital watermark. The method comprises receiving the file to be secured and the watermark to be embedded, which comprises a plurality of bit sequences. The entire file to be secured is divided into a plurality of data blocks, each of which is transformed into a coefficient matrix using a discrete frequency transformation and grouped into a plurality of groups. The watermark is embedded in each group of the plurality of groups, wherein in each group, a coefficient per coefficient matrix assigned to a bit sequence of the watermark is changed depending on a value of the assigned bit sequence. The modified coefficient matrices are each transformed back into a modified data block using an inverse discrete frequency transformation. The resulting modified file is provided.

### TECHNICAL FIELD

The invention relates to a method for securing a file using a digital watermark and a file secured in this manner. The invention also relates to a computer program and a computer device for securing a file using a digital watermark. Finally, the invention relates to a method for identifying the origin of a file to be checked using a digital watermark.

### BACKGROUND

Digital data provided in the form of files is increasingly used in our modern information-based society or rather information society. The modern information society uses information and communication technologies based on file processing in almost all areas of life. One of the characteristics of such files is that they are inexpensive to duplicate. In theory, such digital data or rather files can be made available as often as desired at no additional cost, with virtually no loss of quality due to duplication or rather copying. Files can therefore be duplicated and shared without restriction. In addition, digital files are generally easy to edit and modify.

In view of this, securing such files and, in particular, providing reliable proof of their origin is challenging.

### SUMMARY

It is an objective of the invention to provide an improved method for securing a file using a digital watermark. Furthermore, it is an objective of the invention to provide an improved computer program and an improved computer device for securely protecting a file using a digital watermark. Finally, it is an objective of the invention to provide an improved method for identifying the origin of a file to be checked using a digital watermark.

The objectives underlying the invention are solved by the features of the independent claims.

In one aspect, a computer-implemented method is disclosed for securing a file using a digital watermark. The method comprises receiving the file to be secured. Furthermore, the watermark to be embedded in the file to be secured is received, which is configured as proof of origin of the file to be secured and identifies an origin assigned to the file to be secured. The watermark comprises a plurality of bit sequences. The entire file to be secured is divided into a plurality of data blocks. The data blocks are transformed and grouped into a plurality of groups. The transforming comprises transforming the data blocks, in each case, into a coefficient matrix with a plurality of coefficients of a discrete frequency transformation applied to the corresponding data block. The discrete frequency transformation is one of the following discrete transformations: a discrete cosine transform, a discrete sine transform. Each group is assigned a coefficient matrix for each bit sequence of the watermark.

The watermark is embedded in each group of the plurality of groups. In each group of the plurality of groups, a coefficient per assigned coefficient matrix is changed depending on a value of the bit sequence of the watermark assigned to the corresponding coefficient matrix. The modified coefficient matrices are each transformed back into a modified data block using an inverse discrete frequency transformation applied to the corresponding coefficient matrix, i.e., a frequency transformation inverse to the previously applied frequency transformation. The resulting modified file is provided.

The resulting modified file is secured with the watermark embedded multiple times in redundant form, which identifies the origin assigned to the file as proof of origin.

Such protection of the file may have the advantage of offering a high degree of security while not impairing the use of the protected file due to the embedded watermark.

A digital watermark refers to information that is inserted into a file, such as an image, video, audio, or text file, and is not perceptible in its embedded form. In contrast to metadata, digital watermarks are interwoven directly with the content of the corresponding files to be marked using steganographic methods.

A discrete cosine transform is a real-valued, discrete, linear, orthogonal transform that transforms a time-discrete signal in the case of a time signal from a time domain to a frequency domain, or a space-discrete signal in the case of a spatial signal from a space domain to a frequency domain. A discrete sine transform is also a real-valued, discrete, linear, orthogonal transform that transforms a time-discrete signal in the case of a time signal from a time domain into a frequency domain or a spatially discrete signal in the case of a spatial signal from a spatial domain into the frequency domain.

For example, the watermark comprises an origin ID of the origin assigned to the file to be secured. This origin ID may be used to uniquely identify the origin of the corresponding file. For example, the origin ID is an identifier of a rights holder of the corresponding file to be secured.

For example, the coefficient matrices are grouped sequentially so that the watermark is embedded repeatedly in the file to be secured. For example, the coefficient matrices are grouped according to a predefined pattern so that coefficient matrices from different image areas may belong to the same group. For example, the corresponding predefined pattern is repeated continuously.

For example, a size of the groups of the plurality of groups, i.e., the number of coefficient matrices comprised by the groups, each corresponds to a size of the watermark or rather the number of bit sequences comprised by the watermark. Thus, for example, each of the coefficient matrices of the individual groups may be assigned one of the bit sequences of the watermark.

For example, the size of the groups corresponds exactly to the size of the watermark, so that each coefficient matrix of the groups is assigned to one of the bit sequences of the watermark. For example, a number of coefficient matrices per group corresponds to a number of bit sequences of the watermark.

For example, if the coefficient matrices cannot be divided into groups during the grouping process without remainder, the method further comprises forming an incomplete residual group with a size smaller than the size of the watermark, so that the residual group does not comprise a coefficient matrix assigned to the corresponding bit sequence of the watermark for each bit sequence of the watermark. For example, the watermark is embedded in incomplete form in the incomplete residual group. The incomplete embedding of the watermark in the residual group comprises, for example, changing a coefficient per coefficient matrix of the residual group that is assigned to a bit sequence of the watermark, depending on the value of the corresponding assigned bit sequence of the watermark.

For example, in each group of the plurality of groups, one coefficient per coefficient matrix is changed depending on a value of the bit sequence of the watermark assigned to the corresponding coefficient matrix.

For example, the watermark is embedded in each group of the plurality of groups in such a way that the watermark is introduced multiple times redundantly into different areas of the file to be secured.

For example, the method further comprises generating the file to be secured. For example, the method further comprises generating the watermark to be embedded. For example, the watermark is a file-specific watermark.

A discrete frequency transformation is used to embed the watermark in the file, for example an image file. For example, this discrete frequency transformation is a discrete cosine transform. For example, this discrete frequency transformation is a discrete sine transform.

The image file is, for example, an image file of a grayscale image. For example, a border is added to the image. No components of the watermark are embedded in the border, i.e., the border remains unchanged. Adding a border may have the advantage of making it more difficult for third parties to detect and manipulate watermarks. For example, a 50-pixel border is added to an image measuring 1582×1183 pixels.

For example, no border is added to the image.

The image is divided into blocks. For example, the image is divided into blocks measuring 8×8 pixels. In the case of an image measuring 1480×1080 pixels, the image is divided into 24.975 blocks measuring 8×8 pixels. The blocks are grouped into groups. For example, the blocks are grouped into groups of 4096 blocks. This results in six groups of 4096 blocks each and one group of 399 blocks.

The blocks are grouped using a random generator, for example. The random generator is used to generate one or more sequences of random numbers, which are then used to group the blocks. The random generator is configured, for example, to generate the same sequence of random numbers each time it runs using the same seed.

For each of the blocks, a discrete cosine transform (DCT) or a discrete sine transform (DST) is performed, for example. The DCT or DST, respectively, converts the pixel values of the corresponding block into frequency coefficients. In a resulting coefficient matrix, whose size corresponds, for example, to the size of the corresponding transformed block, different frequency components of the original block are represented. In the case of an 8×8 block, the application of the DCT or DST, respectively, results, for example, in a coefficient matrix that represents 64 different frequency components of the original 8×8 block.

The watermark is provided in the form of an image, for example. For example, the watermark is provided in the form of a black-and-white image. The values of the individual pixels of the watermark may be either white or black. In the case of a binary image, the pixels are assigned pixel values of 1 or 0 for white and black, for example. In this case, the basic bit sequences are, for example, individual bits, each of which defines a pixel value. For example, the black-and-white image can also be a black-and-white image that uses grayscale formatting. In this case, only the pixel values 255 for white and 0 for black are used, for example. In this case, the basic bit sequences are, for example, sequences of 8 bits, each of which defines a pixel value.

The coefficient matrices of the individual groups of the plurality of groups are each assigned to bit sequences of the watermark. For example, a number of blocks per group and thus of coefficient matrices per group resulting from the DCT or DST is equal to or smaller than the number of bit sequences of the watermark. For example, the coefficient matrices are each assigned to pixels of a watermark image. For example, the number of blocks per group and thus the number of coefficient matrices per group resulting from the DCT or DST is equal to or less than the number of pixels of the watermark.

For example, the number of blocks is an integer multiple of the number of bit sequences of the watermark. In this case, each group comprises, for example, a number of blocks and thus coefficient matrices that corresponds to the number of bit sequences of the watermark. For example, each of the coefficient matrices is assigned to one of the bit sequences of the watermark. Thus, each of the groups comprises, for example, a coefficient matrix assigned to the corresponding bit sequence for each of the bit sequences of the watermark.

For example, the number of blocks is not an integer multiple of the number of bit sequences of the watermark. For example, the number of blocks corresponds to an integer multiple of the number of bit sequences of the watermark plus a remainder that is smaller than the number of bit sequences of the watermark. In this case, the blocks may be grouped in such a way that a plurality of groups results, the number of blocks and thus coefficient matrices of which corresponds to the number of bit sequences of the watermark, plus a residual group comprising the blocks of the remainder. The number of blocks comprised by the residual group corresponds to the remainder of blocks, which is smaller than the number of bit sequences of the watermark.

For example, each of the coefficient matrices of the groups whose number of blocks corresponds to the number of bit sequences of the watermark is assigned to one of the bit sequences of the watermark. Thus, each of these groups comprises, for example, for each of the bit sequences of the watermark a coefficient matrix assigned to the corresponding bit sequence. The coefficient matrices of the residual group are also assigned to one of the bit sequences of the watermark, for example. However, the residual group only comprises a coefficient matrix assigned to the corresponding bit sequences for a portion of the bit sequences of the watermark. For example, the residual group comprises N coefficient matrices that are assigned to the first N bit sequences of the watermark, which comprises M bit sequences with N<M and N, M∈N.

For example, for each bit sequence of the watermark in the groups of the plurality of groups, those transformed blocks of the file, i.e., coefficient matrices, which are assigned to the corresponding bit sequence are modified. For example, for each pixel of a watermark in the form of a black-and-white image in the groups of the plurality of groups, those transformed blocks of the file, i.e., coefficient matrices, which are assigned to the corresponding bit sequence are modified. If, for example, each of the groups comprises a coefficient matrix assigned to the corresponding bit sequence, a coefficient matrix is modified in each group depending on this bit sequence. If, for example, each of the groups except for one residual group of the plurality of groups comprises a coefficient matrix assigned to the corresponding bit sequence, a coefficient matrix is modified in each of the corresponding groups except for the residual group depending on this bit sequence.

For example, the size of a watermark image, such as a black-and-white image, is 64×64 pixels=4096 pixels. For example, an image file with a size of 1480×1080 pixels is divided into 185×135=24.975 blocks with a size of 8×8 pixels. If these 24.975 blocks are divided into groups of 4096 blocks, this results in, for example, six groups of 4096 blocks each and one residual group of 399 blocks. The six groups of 4096 blocks each comprise, for example, an assigned coefficient matrix for each pixel of the watermark image. The residual group comprises an assigned coefficient matrix for each pixel of a part of pixels of the watermark image, or more precisely for 399 pixels. For 3697 pixels of the watermark image, the residual group does not comprise an assigned coefficient matrix. This means that the watermark image may be embedded completely in six groups and partially in the residual group.

For each pixel of the 64×64 pixel=4096 pixel black-and-white watermark image, those DCT-transformed blocks, i.e., coefficient matrices, in the file, for example, a grayscale image, which are assigned to the corresponding pixel are modified. For example, in the six groups with 4096 blocks, 4096 blocks are modified in each group, while in the residual group with 399 blocks, 399 blocks are modified.

If a pixel in the black-and-white watermark image is white, a coefficient of the coefficient matrix assigned to the pixel is modified, for example, in a first manner. White means, for example, that a value of the bit sequence defining the corresponding pixel is 1 for a binary-formatted black-and-white image or 255 for a grayscale-formatted black-and-white image. If a pixel in the black-and-white watermark image is black, a coefficient assigned to the pixel in the coefficient matrix is modified in a second manner, for example. Black means, for example, that a value of the bit sequence defining the corresponding pixel is 0 for a binary or grayscale formatted black-and-white image.

For example, the coefficient in question, such as a first coefficient of the corresponding coefficient matrix, is rounded to an even value, for example rounded down, in the case of a white pixel or rather a pixel value for white, and rounded to an odd value, for example rounded down, in the case of a black pixel or rather a pixel value for black. Such rounding may also be performed, for example, for or from a certain number of decimal places. Thus, digit positions of a power of ten 10⁻ⁿ may also be used with suitable n∈N.

After modifying the coefficient matrices, an inverse DCT or DST is performed. In this process, the blocks or rather coefficient matrices are transformed, for example, from the frequency domain back to a data value range, such as an image or rather pixel value range in the case of an image file. The resulting modified file thus comprises the modified blocks. For example, a resulting modified image file, such as a modified grayscale image, comprises the modified blocks of grayscale pixel values.

Extracting and checking the watermark may be done, for example, using a reverse process.

For example, the assigned blocks are identified for each of the bit sequences of the watermark. Since the watermark is embedded multiple times in redundant form in the modified file, it is generally sufficient, for example, to identify one assigned block for each of the bit sequences of the watermark to be checked. For example, more than one assigned block of the modified file is identified for each bit sequence of the watermark to be checked. For example, all assigned blocks of the modified file are identified for each bit sequence of the watermark to be checked. The one or more additional blocks may be used for checking, for example.

If the assignment of the coefficients to the bit sequences of the watermark was performed on a random basis during embedding, for example using a deterministic random algorithm, the same random-based assignment is reproduced during checking, for example using the same deterministic random algorithm. For example, the same seed value is used in each case to determine the random-based assignment.

The blocks of the modified file to be checked are subjected to a DCT or DST.

The coefficients of the resulting coefficient matrices, which are assigned to the bit sequences of the watermark, are used to check whether the watermark or which watermark is embedded in them. For example, a property of the corresponding coefficients, such as whether they are even or odd, may be used to determine a value of the assigned bit sequences of the watermark, such as a pixel value. For example, for an even coefficient, the assigned pixel value of a watermark in the form of a black-and-white image is set to white. In the case of grayscale formatting, this means, for example, that the assigned bit sequence is set to the value 255. In the case of binary formatting, this means, for example, that the assigned bit sequence is set to the value 1. For example, for an odd coefficient, the assigned pixel value of a watermark in the form of a black-and-white image is set to black. For grayscale formatting as well as for binary formatting, this means, for example, that the assigned bit sequence is set to the value 0.

Alternatively, a DCT-transformed reference file may be provided, wherein the reference file corresponds to the file to be checked without the embedded watermark. For example, differences between the coefficient matrices and the DCT-transformed reference file are determined. Using the differences, for example, the watermark is determined.

For example, the watermark may be embedded using the DCT or DST in such a way that it is practically invisible to the human eye. This may be the case in particular if the changes in the coefficients occur in a frequency range to which the human eye is comparatively less sensitive. For example, the higher the frequency, the less sensitive the human eye is. At the same time, it is possible to extract the watermark from the image by reversing the process and analyzing the DCT coefficients.

In images, for example, DCT or DST may be used to convert pixel values of a block of pixels, i.e., a segment of the image, into a coefficient matrix with frequency coefficients. These coefficients represent the intensity of different frequency patterns or rather frequency components in the corresponding block or image segment. Low-frequency components describe basic, widespread patterns, while high-frequency components represent fine details and edges.

The low-order coefficients, i.e., matrix elements of the coefficient matrix with low-order coefficients, represent low-frequency components of the file, followed by medium-order coefficients, i.e., matrix elements of the coefficient matrix with medium coefficients, which represent medium frequency components of the file, and high coefficients, i.e., matrix elements of the coefficient matrix with high coefficients, which represent high frequency components of the file.

The first element or rather coefficient of a DCT coefficient matrix, also referred to as the DC coefficient, represents an average pixel value of the pixels within a corresponding block. This coefficient can also be considered as the base level or DC component of the corresponding block.

The remaining coefficients in the coefficient matrix represent the intensity and phase of the various cosine or sine waves required to reconstruct the original pixel values of the block. These coefficients are also referred to as AC coefficients. The AC coefficients are arranged in the coefficient matrix in ascending order of frequency: the coefficients close to the DC coefficient represent lower frequencies, while the coefficients further away represent higher frequencies.

The DCT or DST has the advantage that it tends to concentrate the energy of a transformed signal, such as an image, into a few coefficients. This means that many coefficients are small. This is advantageous for the watermarking process, as changes to the DCT coefficients, especially high-frequency coefficients, are difficult for the human eye to detect, so the watermark remains hidden.

A variation, especially a random-based variation of the coefficient in the coefficient matrices that is modified in each case, may have the advantage of enabling a better securing of the watermark. For example, this may prevent an attacker from removing the watermark by transforming the modified file using a DCT or DST and specifically changing or setting the same coefficient to zero in all coefficient matrices.

Embedding watermark data in all blocks of the file to be secured may have the advantage that the watermark is distributed throughout the entire file and is therefore less susceptible to targeted attacks or loss due to editing of the file, for example, image editing in the case of an image file. If a file, such as an image file, is scaled, cropped, and/or otherwise manipulated, the positions of individual blocks within the file may change. If only these individual blocks contain watermark data, the watermark may be lost or become illegible because the information necessary to reconstruct the watermark can no longer be correctly assigned. This risk may be reduced, for example, by ensuring that all blocks of the file to be secured contain watermark data.

Using a reproducible random generator to select the coefficients to be modified may have the advantage of making it more difficult to remove the watermark from the modified file, since without knowledge of the seed value, it is not possible to determine which coefficients have been modified and thus carry the watermark data.

Using coefficients from the low to medium frequency range may have the advantage that the embedding of the watermark in this case is less susceptible to changes caused by noise or smoothing filters. Coefficients representing low to medium frequencies are generally less susceptible to changes caused by noise or smoothing filters. Such changes primarily affect high-frequency coefficients. Embedding the watermark in the coefficients from the low to medium frequency range may therefore prevent the watermark from being removed from the modified file by deliberately changing high-frequency coefficients, for example by means of noise or smoothing.

This may also prevent the watermark from being disrupted or removed by compression algorithms and other image processing processes. With such compression algorithms and other image processing processes, high-frequency coefficients are often the first coefficients to be changed or discarded. Embedding the watermark in the coefficients from the low to medium frequency range can therefore prevent the watermark from being removed from the modified file by deliberately changing high-frequency coefficients, for example by means of a compression algorithm or another image processing process.

Using coefficients from the low to medium frequency range may therefore increase the robustness of the watermark embedding in the file against targeted attacks as well as against common image processing techniques. By distributing the watermark across the entire file using multiple redundant embeddings and using a reproducible but random selection process for the modified coefficients, i.e., the coefficients in which the watermark data is embedded, it becomes more difficult for attackers to remove the watermark without significantly damaging the watermark-protected file itself. This makes it more difficult and/or impossible to use the file after the watermark has been removed.

The watermark is embedded multiple times in the file to be protected, which creates redundancy. Multiple embedding of the watermark increases the chance that at least part of the watermark will remain intact even after the file has been manipulated, such as through image editing. This may even be the case if entire parts of the file are changed or even deleted.

When embedding the watermark, corresponding additional predefined bit sequences may be used as markers or identifiers to identify the beginning and/or end of the watermark information within the file. These markers may be implemented as special bit sequences which, for example, encode special text identifiers or two-dimensional patterns and frame the watermark. In the case of a watermark in the form of a text sequence, the markers may, for example, mark the beginning and end of the corresponding text, i.e., frame it one-dimensionally. In the case of a watermark in the form of an image file, the markers may, for example, form a two-dimensional frame of the corresponding image file and thus frame the watermark two-dimensionally.

The use of start and end sequences may have the advantage that they may mark the beginning and end of the watermark, which may facilitate the correct extraction of the watermark information.

Even if the modified file is edited after the watermark has been embedded, for example cropped and/or scaled, at least parts of the multiple embedded watermark remain intact. The use of identifiers that mark the beginning and end of the watermark embedded multiple times in the file may make it easier to recognize and assign the remaining parts of the watermark. Even if only fragments of the watermark are present, recognizing the identifiers can facilitate the reconstruction of the complete watermark.

Examples allow different preserved fragments of the watermark embedded multiple times in redundant form in the file, which are distributed across the image, to be combined to form the corresponding watermark. In this way, a complete watermark may be reconstructed even if no single fragment of the watermark is complete.

This approach may increase the robustness of the watermark embedding against manipulation, as it does not rely on the physical integrity of the entire watermark, but rather makes use of parts or rather fragments of it to reconstruct the watermark.

Examples not only make it possible to embed a watermark in a file in such a way that it is virtually invisible to the human eye, but also ensure that the embedding is robust against image manipulation. In particular, the embedding may be robust against scaling and/or cropping of the file, for example. This may provide a more robust method for embedding a watermark in a file to be secured.

For example, the watermark may be positioned flexibly during embedding in the file to be secured in order to make the embedding more resistant to changes.

For example, the plurality of bit sequences comprises one or more identifiers in the form of one or more sets of one or more predetermined bit sequences that frame the watermark and mark a beginning and an end of the watermark.

Examples may have the advantage that the identifiers in the form of the predetermined bit sequences may be used to determine the boundaries of the copies of the watermark embedded in the file. For example, it may be determined where a copy of the watermark begins and another ends. In particular, if the file has been edited so that the positions of watermarks within the file have shifted and/or the file has been cropped, and the edited file contains incomplete copies of the watermark, the identifiers may be used to identify different fragments of the watermark and, if necessary, distinguish them from one another.

In the case of a linear data structure of the watermark, for example in the case of a text sequence, an audio sequence, and/or a video sequence, which is inserted multiple times in succession into the file to be secured, which also has a linear data structure, for example, the identifiers frame the copies of the watermark by being arranged at the beginning and end of the watermark. For example, the file to be secured with the linear data structure is a text file, audio file, or video file.

In the case of a two-dimensional data structure of the watermark, such as in the case of an image file or a video sequence comprising a plurality of frames, which is inserted multiple times in succession into the file to be secured, which also has a two-dimensional data structure, for example, the identifiers frame the copies of the watermark. For this purpose, the identifiers form, for example, a two-dimensional frame that forms a border of the watermark and extends around it. For example, the file to be secured with the two-dimensional data structure is a text file or video file.

A video sequence or video file may be considered linear in terms of its temporal progression. In terms of the individual frames, a video sequence or video file may also be considered a data structure composed of a plurality of two-dimensional individual structures and is thus itself also a two-dimensional data structure.

A text sequence or text file may be considered linear in terms of the direction of writing. In terms of the arrangement of the text, for example in a page format, a text sequence or text file may also be considered a two-dimensional data structure.

For example, the watermark further comprises a check value, such as a checksum. For example, the watermark comprises the check value at its end. For example, the watermark comprises the check value at its end before an identifier that marks the corresponding end of the watermark. The check value enables, for example, the detection of an incorrect extraction of the watermark from the secured file, i.e., from the resulting modified file with the watermark embedded multiple times in redundant form.

For example, within the groups, those coefficients of the coefficient matrices of the corresponding group which are changed depending on the value of the bit sequence of the watermark assigned to the corresponding coefficient matrix are varied according to a predefined first distribution.

Examples may have the advantage that the same coefficient is not changed in each of the coefficient matrices. Rather, within the groups, the coefficients in the coefficient matrices that are changed are varied. Not changing in each case within a group of coefficient matrices the same coefficient makes it more difficult for an attacker to disrupt or remove the embedding of the watermark by deliberately manipulating a specific coefficient per coefficient matrix.

For example, the predefined first distribution is a first random distribution reproducible using the same first initialization data.

Examples may have the advantage that the first random distribution is reproducible using the first initialization data. Thus, for example, the first random distribution may be reproduced using the first initialization data to check the embedded watermark, thereby determining the changed coefficients in the coefficient matrices resulting from a DCT or DST of the changed file. These changed coefficients are those coefficients of the coefficient matrices into which the watermark data is encoded during embedding.

The initial initialization data is, for example, a first seed value. This first seed value makes it possible, for example, to reproduce the first random distribution using a deterministic random generator or a deterministic random algorithm.

For example, the initial initialization data is assigned to an intended recipient of the file to be secured. For example, the initial initialization data comprise a recipient ID of the intended recipient of the file to be secured.

For example, the first random distribution thereby is also recipient-dependent. This results in different initialization data for different recipients of files to be secured with different recipient IDs. These different initialization data for the different recipients lead to different random distributions, which are used to embed watermarks in files to be secured for the corresponding recipients.

For example, within the groups, a type of change in the coefficients of the coefficient matrices of the corresponding group, which are changed depending on the value of the bit sequence of the watermark assigned to the corresponding coefficient matrix, is varied according to a predefined second distribution.

For example, the predefined second distribution is a second random distribution reproducible using the same second initialization data.

For example, the second initialization data is assigned to the intended recipient of the file to be secured. For example, the second initialization data comprise the recipient ID of the intended recipient of the file to be secured.

For example, the coefficients of the coefficient matrices are assigned to different frequencies. The frequencies are divided into at least frequencies of a low frequency range and a high frequency range. Coefficients of the coefficient matrices that are assigned to frequencies of the high frequency range are excluded from the change depending on the watermark.

For example, the frequencies are divided into frequencies of a low frequency range, a medium frequency range, and a high frequency range.

For example, the watermark is also assigned to an intended recipient of the file to be secured and configured to identify the intended recipient.

For example, the watermark comprises the recipient ID of the intended recipient of the file to be secured.

For example, the method further comprises receiving the recipient ID and generating the watermark using the recipient ID. Furthermore, the method further comprises, for example, sending the provided file to the recipient. The sent file is secured in a recipient-specific manner with the watermark comprising the recipient ID.

For example, parameters are stored in a register which describe the embedding of the watermark in the file to be secured and are configured to enable a check of the resulting modified file for the presence of the watermark in the corresponding file.

For example, the parameters comprise one or more of the following parameters: the source ID, the recipient ID, the first initialization data, a first ID of a first algorithm to be used to generate the first random distribution, the second initialization data, a second ID of a second algorithm to be used to generate the second random distribution.

For example, changing the coefficients of the coefficient matrices depending on the bit sequences of the watermark comprises one or more of the following types of changes: bit sequence-dependent changing of a bit of the coefficients, bit sequence-dependent selection of a decimal place of the coefficients to be changed, bit sequence-dependent addition and subtraction of a predefined value from the coefficients, bit sequence-dependent rounding up and rounding down of the coefficients, bit sequence-dependent rounding up of the coefficients to even and odd values, bit sequence-dependent rounding down of the coefficients to even and odd values.

For example, changing the coefficients of the coefficient matrices depending on the bit sequences of the watermark comprises bit sequence-dependent changing of a bit of the coefficients.

For example, changing the coefficients of the coefficient matrices depending on the bit sequences of the watermark comprises bit sequence-dependent selection of a decimal place of the coefficients to be changed.

For example, changing the coefficients of the coefficient matrices depending on the bit sequences of the watermark comprises adding and subtracting a predefined value from the coefficients depending on the bit sequence.

For example, changing the coefficients of the coefficient matrices depending on the bit sequences of the watermark comprises bit sequence-dependent rounding up and rounding down of the coefficients.

For example, changing the coefficients of the coefficient matrices depending on the bit sequences of the watermark comprises bit sequence-dependent rounding up of the coefficients to even and odd values.

For example, changing the coefficients of the coefficient matrices depending on the bit sequences of the watermark comprises bit sequence-dependent rounding down of the coefficients to even and odd values.

For example, the file to be secured is a digital file. For example, the file to be secured is one of the following types of files: an image file, an audio file, a video file, a text file.

For example, the watermark is one of the following types: a character string, a text file, an image file, an audio sequence.

For example, the bit sequence is a basic bit sequence that defines a character of a character string.

For example, the bit sequence is a basic bit sequence that defines a text character of a text file.

For example, the bit sequence is a basic bit sequence that defines a sample or rather sample value of an audio sequence.

For example, the bit sequence is a basic bit sequence that defines a pixel of an image file.

In a further aspect, a computer-implemented method is disclosed for identifying the origin of a file to be checked using a digital watermark that is embedded multiple times in redundant form in the file using a method according to one of the examples described above and indicates the origin to be identified. The method comprises receiving the file to be checked. The file to be checked is divided into a plurality of data blocks. At least some of the data blocks are each transformed into a coefficient matrix with a plurality of coefficients of a discrete frequency transformation applied to the corresponding data block, such as a cosine transform or sine transform.

The watermark embedded in the file to be checked is determined using the coefficient matrices resulting from the transformed data blocks. In each of the coefficient matrices, a coefficient modified in dependence on a value of a bit sequence of the watermark assigned to the corresponding coefficient matrix is determined. The respective assigned bit sequence is determined using the corresponding coefficient. The origin assigned to the file to be checked is identified using the determined watermark.

For example, the method further comprises receiving a reference file transformed using a discrete frequency transformation, such as a cosine transform or sine transform. The reference file corresponds to the file to be checked without an embedded watermark. For example, in the course of determining the watermark embedded in the file to be checked, differences are determined between the coefficient matrices resulting from the transformed data blocks of the file to be checked and the reference file transformed using the discrete frequency transformation, such as a cosine transform or sine transform.

For example, the method first comprises securing a file using a digital watermark. For this purpose, the file to be secured is received. Furthermore, the watermark to be embedded in the file to be secured is received, which is configured as a proof of origin of the file to be secured and identifies an origin assigned to the file to be secured. The watermark comprises a plurality of bit sequences. The entire file to be secured is divided into a plurality of data blocks. The data blocks are each transformed into a coefficient matrix with a plurality of coefficients of a discrete frequency transformation, such as a cosine transform or sine transform, applied to the corresponding data block. The coefficient matrices are grouped into a plurality of groups. In doing so, a coefficient matrix is assigned to all groups for each bit sequence of the watermark.

The watermark is embedded in each group of the plurality of groups. In each group of the plurality of groups, a coefficient per assigned coefficient matrix is changed depending on a value of the bit sequence of the watermark assigned to the corresponding coefficient matrix. The modified coefficient matrices are each transformed back into a modified data block using an inverse discrete frequency transformation applied to the corresponding coefficient matrix, such as a cosine transform or a sine transform. The resulting modified file is provided.

Furthermore, the method comprises, in particular at a later stage, for example, identifying the origin of a file to be checked using a digital watermark. The file to be checked is the modified file provided, and the watermark is the watermark embedded multiple times in redundant form in the modified file provided, which indicates the origin of the file to be identified. To identify the origin, the file to be checked is received. Furthermore, a reference file transformed using a discrete frequency transformation is received. The discrete frequency transformation is one of the following discrete transformations: a discrete cosine transform, a discrete sine transform. The reference file corresponds to the file to be checked without an embedded watermark. The file to be checked is divided into a plurality of data blocks. The data blocks are each transformed into a coefficient matrix with a plurality of coefficients of a discrete frequency transformation applied to the corresponding data block. The discrete frequency transformation is one of the following discrete transformations: a discrete cosine transform, a discrete sine transform.

Differences are determined between the coefficient matrices resulting from the transformed data blocks of the file to be checked and the reference file transformed using the discrete frequency transformation, such as a cosine transform or a sine transform. The watermark embedded in the file to be checked is determined using the differences determined. Using the determined watermark, the origin assigned to the file to be checked is identified.

For example, securing the file using the watermark and identifying the origin of the file to be checked are performed using one and the same computer device. For example, securing the file using the watermark and identifying the origin of the file to be checked are performed using different computer devices.

In a further aspect, a secured file is disclosed in which, for security purposes, a watermark that identifies an origin assigned to the file as proof of origin is embedded multiple times in redundant form using one of the preceding examples of a method for securing a file using a digital watermark.

In a further aspect, a computer program is disclosed for securing a file using a digital watermark. The computer program comprises machine-readable program instructions. Execution of the machine-readable program instructions by a processor unit of a computer device causes the computer device to receive the file to be secured. Furthermore, the watermark to be embedded in the file to be secured is received, which is configured as proof of origin of the file to be secured and identifies an origin assigned to the file to be secured. The watermark comprises a plurality of bit sequences. The entire file to be secured is divided into a plurality of data blocks. The data blocks are transformed and grouped into a plurality of groups. The transforming comprises transforming the data blocks into a coefficient matrix with a plurality of coefficients of a discrete frequency transformation applied to the corresponding data block. The discrete frequency transformation is one of the following discrete transformations: a discrete cosine transform, a discrete sine transform. Each group is assigned a coefficient matrix for each bit sequence of the watermark.

The watermark is embedded in each group of the plurality of groups. In each group of the plurality of groups, a coefficient per assigned coefficient matrix is changed depending on a value of the bit sequence of the watermark assigned to the corresponding coefficient matrix. The modified coefficient matrices are each transformed back into a modified data block using an inverse discrete frequency transformation applied to the corresponding coefficient matrix. The resulting modified file is provided.

For example, the machine-readable program instructions of the computer program are configured to control the computer unit, when executed by a processor unit of a computer unit, to execute each of the examples described herein of a method for securing a file using a digital watermark.

For example, the machine-readable program instructions of the computer program are configured to further control the computer unit, when executed by a processor unit of a computer unit, to execute each of the examples described herein of a method for identifying an origin of a file to be checked using a digital watermark.

For example, a computer program product for securing a file using a digital watermark comprises a computer-readable storage medium having machine-readable program instructions embodied therein. Execution of the machine-readable program instructions by a processor unit of a computer device causes the computer device to receive the file to be secured. Furthermore, the watermark to be embedded in the file to be secured is received, which is configured as a proof of origin of the file to be secured and identifies an origin assigned to the file to be secured. The watermark comprises a plurality of bit sequences. The entire file to be secured is divided into a plurality of data blocks. The data blocks are transformed and grouped into a plurality of groups. The transforming comprises transforming the data blocks, in each case, into a coefficient matrix with a plurality of coefficients of a discrete frequency transformation applied to the corresponding data block. The discrete frequency transformation is one of the following discrete transformations: a discrete cosine transform, a discrete sine transform. Each group is assigned a coefficient matrix for each bit sequence of the watermark.

The watermark is embedded in each group of the plurality of groups. In each group of the plurality of groups, a coefficient per assigned coefficient matrix is changed depending on a value of the bit sequence of the watermark assigned to the corresponding coefficient matrix. The modified coefficient matrices are each transformed back into a modified data block using an inverse discrete frequency transformation applied to the corresponding coefficient matrix. The resulting modified file is provided.

For example, the machine-readable program instructions embodied in the computer-readable storage medium of the computer program product are configured to control the computer unit, when executed by a processor unit of a computer unit, to execute each of the examples described herein of a method for securing a file using a digital watermark.

For example, the machine-readable program instructions embodied in the computer-readable storage medium of the computer program product are further configured to, when executed by a processor unit of a computer unit, control the computer unit to execute each of the examples described herein of a method for identifying an origin of a file to be checked using a digital watermark.

In a further aspect, a computer device is disclosed for securing a file using a digital watermark. The computer device comprises a processor unit and a storage unit with machine-readable program instructions. Execution of the machine-readable program instructions by the processor unit causes the computer device to receive the file to be secured. Furthermore, the watermark to be embedded in the file to be secured is received, which is configured as proof of origin of the file to be secured and identifies an origin assigned to the file to be secured. The watermark comprises a plurality of bit sequences. The entire file to be secured is divided into a plurality of data blocks. The data blocks are transformed and grouped into a plurality of groups. The transforming comprises transforming the data blocks, in each case, into a coefficient matrix with a plurality of coefficients of a discrete frequency transformation applied to the corresponding data block. The discrete frequency transformation is one of the following discrete transformations: a discrete cosine transform, a discrete sine transform. Each group is assigned a coefficient matrix for each bit sequence of the watermark.

The watermark is embedded in each group of the plurality of groups. In each group of the plurality of groups, a coefficient per assigned coefficient matrix is changed depending on a value of the bit sequence of the watermark assigned to the corresponding coefficient matrix. The modified coefficient matrices are each transformed back into a modified data block using an inverse discrete frequency transformation applied to the corresponding coefficient matrix. The resulting modified file is provided.

For example, the machine-readable program instructions of the storage unit of the computer device are configured to control the computer unit, when executed by the processor unit of the computer unit, to execute each of the examples described herein of a method for securing a file using a digital watermark.

For example, the machine-readable program instructions of the storage unit of the computer device are further configured to control the computer unit, when executed by the processor unit of the computer unit, to execute each of the examples described herein of a method for identifying an origin of a file to be checked using a digital watermark.

It is understood that one or more of the aforementioned embodiments may be combined as long as the embodiments are not mutually exclusive.

### BRIEF DESCRIPTION OF THE DRAWINGS

In the following, examples are described in greater detail making reference to the drawings. They show:

FIG. 1 a flowchart of an exemplary method for securing a file using a digital watermark,

FIG. 2 a flowchart of an exemplary method for identifying the origin of a file to be checked using a digital watermark,

FIG. 3 a flowchart of an exemplary method for identifying an origin of a file to be checked using a digital watermark,

FIG. 4 a flowchart of an exemplary method for identifying an origin of a file to be checked using a digital watermark,

FIG. 5 an exemplary coefficient matrix,

FIG. 6 an exemplary coefficient matrix,

FIG. 7 an exemplary digital watermark in the form of an image file,

FIG. 8 an exemplary image file in the form of a chest X-ray image,

FIG. 9 an example image file in the form of a chest X-ray image with an embedded watermark,

FIG. 10 exemplary data blocks of a file to be secured,

FIG. 11 exemplary modified data blocks of a secured file,

FIG. 12 an example data block from a file to be secured, FIG. 13 an exemplary modified data block of a secured file,

FIG. 14 an exemplary data block of a file to be secured,

FIG. 15 an exemplary modified data block of a secured file,

FIG. 16 exemplary amplitude distributions,

FIG. 17 exemplary modified data blocks of a secured file, FIG. 18 an exemplary data block of a file to be secured,

FIG. 19 an exemplary modified data block of a secured file,

FIG. 20 an exemplary modified data block of a secured file,

FIG. 21 exemplary amplitude distributions,

FIG. 22 an exemplary overview of an effect of embedding a digital watermark on an analysis of files using a machine learning module,

FIG. 23 an exemplary system for securing files and identifying origins of the secured files,

FIG. 24 a block diagram of an exemplary computer device for securing a file using a digital watermark, and

FIG. 25 a block diagram of an exemplary computer device for identifying an origin of a file to be checked using a digital watermark.

### DETAILED DESCRIPTION

In the following, similar elements are identified with the same reference signs.

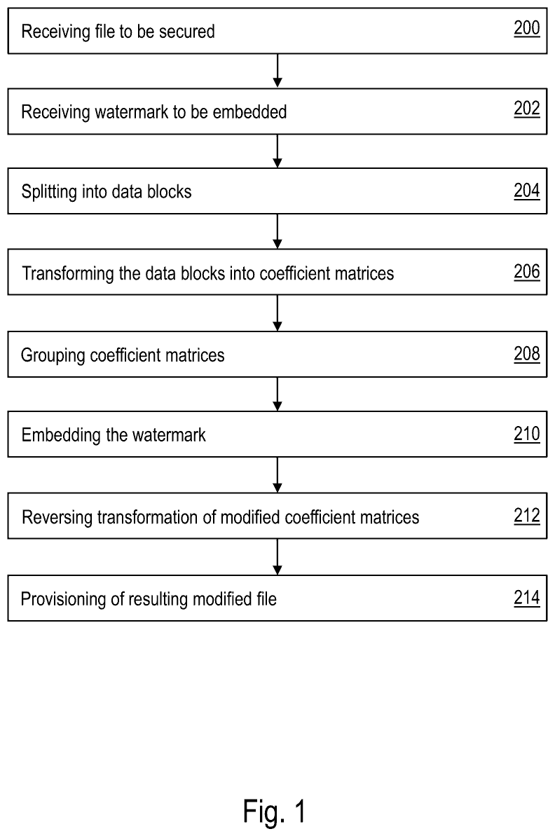

FIG. 1 shows an exemplary method for securing a file using a digital watermark. In block 200, the file to be secured is received. In block 202, the watermark to be embedded in the file to be secured is received. This watermark is configured as proof of origin of the file to be secured and identifies an origin assigned to the file to be secured. The watermark comprises a plurality of bit sequences. In block 204, the entire file to be secured is divided into a plurality of data blocks. In block 206, the data blocks are each transformed into a coefficient matrix with a plurality of coefficients of a discrete frequency transformation applied to the corresponding data block. The discrete frequency transformation is one of the following discrete transformations: a discrete cosine transform, a discrete sine transform. In block 208, the coefficient matrices are grouped into a plurality of groups. In doing so, a coefficient matrix is assigned to all groups for each bit sequence of the watermark.

In block 210, the watermark is embedded in each group of the plurality of groups. For this purpose, in each group of the plurality of groups, a coefficient per assigned coefficient matrix is changed depending on a value of the bit sequence of the watermark assigned to the corresponding coefficient matrix. In block 212, the modified coefficient matrices are each transformed back into a modified data block using an inverse discrete frequency transformation applied to the corresponding coefficient matrix, for example, an inverse cosine transform or an inverse sine transform. In block 214, the resulting modified file is provided.

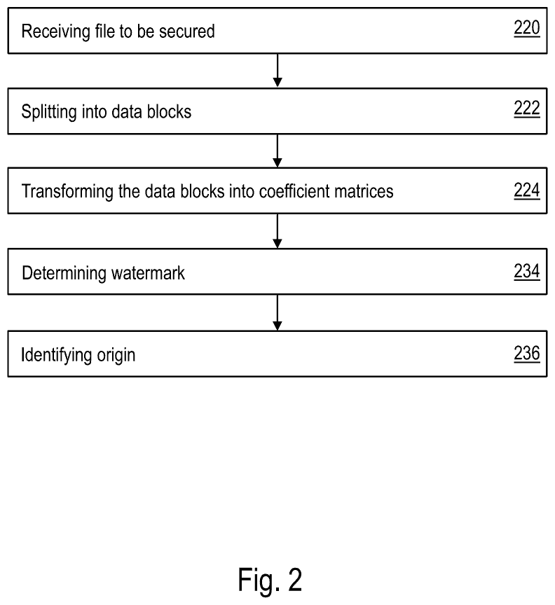

FIG. 2 shows an example method for identifying an origin of a file to be checked using a digital watermark. This watermark is embedded multiple times in redundant form in the file to be checked, for example according to the method shown in FIG. 1. This multiple embedded watermark indicates the origin of the file to be identified. In block 220, the file to be checked is received. In block 222, the file to be checked is divided into a plurality of data blocks. In block 224, the data blocks are each transformed into a coefficient matrix with a plurality of coefficients of a discrete frequency transformation applied to the corresponding data block. The discrete frequency transformation is one of the following discrete transformations: a discrete cosine transform, a discrete sine transform.

In block 234, the watermark embedded in the file to be checked is determined using the coefficient matrices. For example, an assigned coefficient matrix and the coefficient modified depending on the assigned bit sequence are determined for each bit sequence of the watermark. The watermark is reconstructed using the coefficients determined in this way. For example, the coefficients were modified so that their values are even or odd depending on the values of the bit sequences. Thus, based on the fact that the coefficients are even or odd, a watermark in the form of a black-and-white image may be reconstructed, for example. In block 236, the origin assigned to the file to be checked is identified using the determined watermark.

For example, a method first comprises securing the file using the watermark, for example using the method according to FIG. 1. For example, the method further comprises checking the file using the watermark embedded in the secured file. The checking comprises identifying the origin of the file using the embedded watermark or rather based on the embedded watermark. This identification of the origin of the file to be checked is performed, for example, using the method shown in FIG. 2.

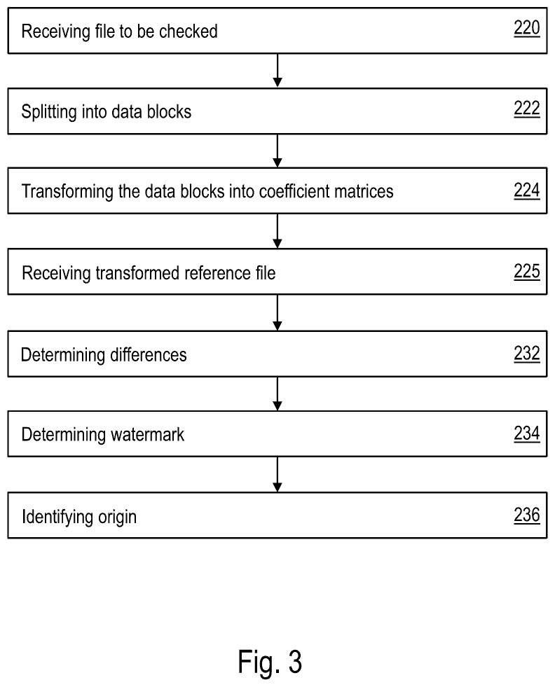

FIG. 3 shows another example method for identifying an origin of a file to be checked using a digital watermark. This watermark is embedded in the file to be checked multiple times in redundant form, for example, according to the method shown in FIG. 1. This multiple embedded watermark indicates the origin of the file to be identified. In block 220, the file to be checked is received. In block 222, the file to be checked is divided into a plurality of data blocks. In block 224, the data blocks are each transformed into a coefficient matrix with a plurality of coefficients of a discrete frequency transformation applied to the corresponding data block. The discrete frequency transformation is one of the following discrete transformations: a discrete cosine transform, a discrete sine transform.

In block 225, a reference file transformed using a discrete frequency transformation, for example a cosine transform or a sine transform, is received. The reference file corresponds to the file to be checked without an embedded watermark.

In block 232, differences between the coefficient matrices resulting from the transformed data blocks of the file to be checked and the reference file transformed using the discrete frequency transformation are determined. In block 234, the watermark embedded in the file to be checked is determined using the differences determined. In block 236, the origin assigned to the file to be checked is identified using the determined watermark.

For example, a method initially comprises securing the file using the watermark, for example using the method shown in FIG. 1. For example, the method further comprises checking the file using the watermark embedded in the secured file. The checking comprises identifying the origin of the file using the embedded watermark or rather based on the embedded watermark. This identification of the origin of the file to be checked is performed, for example, using the method shown in FIG. 3.

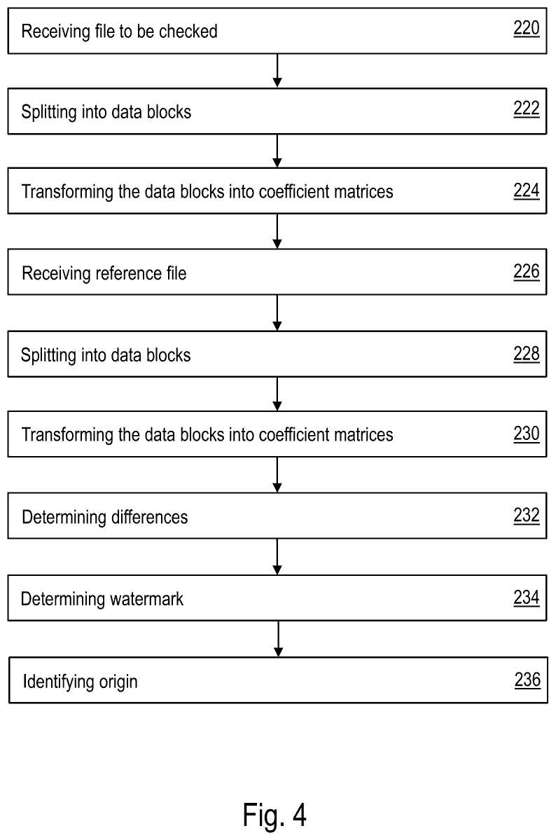

FIG. 4 shows another example of a method for identifying an origin of a file to be checked using a digital watermark. This watermark is embedded in the file to be checked multiple times in redundant form, for example, according to the method of FIG. 1. This multiple embedded watermark indicates the origin of the file to be identified. In block 220, the file to be checked is received. In block 222, the file to be checked is divided into a plurality of data blocks. In block 224, the data blocks are each transformed into a coefficient matrix with a plurality of coefficients of a discrete frequency transformation applied to the corresponding data block. The discrete frequency transformation is one of the following discrete transformations: a discrete cosine transform, a discrete sine transform.

In block 226, a reference file is received which corresponds to the file to be checked without an embedded watermark. In block 228, the received reference file is divided into a plurality of data blocks. In block 230, the data blocks are each transformed into a coefficient matrix with a plurality of coefficients of a discrete frequency transformation applied to the corresponding data block, such as a cosine transform or a sine transform. The result is a reference file transformed using a discrete frequency transformation.

In block 232, differences are determined between the coefficient matrices resulting from the transformed data blocks of the file to be checked and the reference file transformed using the discrete frequency transformation. In block 234, the watermark embedded in the file to be checked is determined using the determined differences. In block 236, the origin assigned to the file to be checked is identified using the determined watermark.

For example, a method initially comprises securing the file using the watermark, for example using the method according to FIG. 1. For example, the method further comprises checking the file using the watermark embedded in the secured file. The checking comprises identifying the origin of the file using the embedded watermark or rather based on the embedded watermark. This identification of the origin of the file to be checked is performed, for example, using the method shown in FIG. 4.

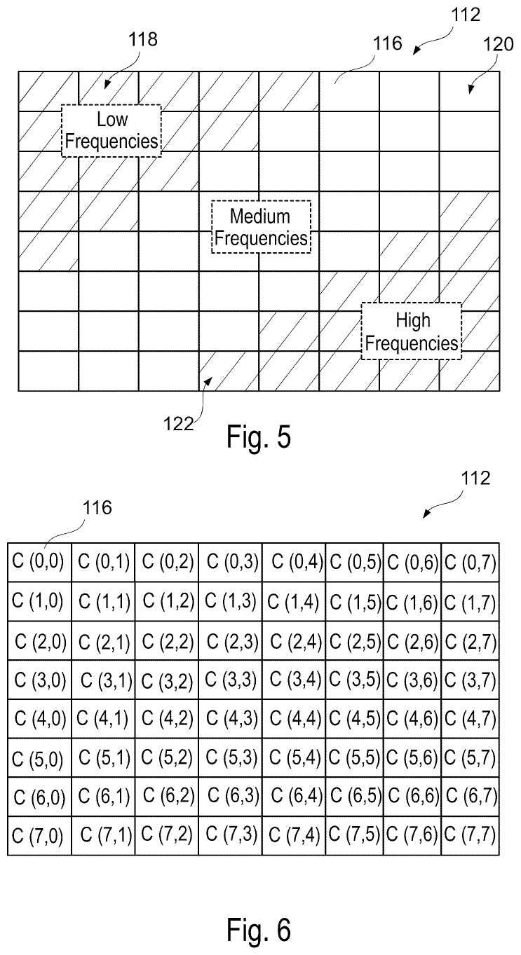

FIG. 5 illustrates an exemplary coefficient matrix 112. The coefficient matrix 112 results from a discrete frequency transformation of a data block. The discrete frequency transformation is, for example, a discrete cosine transform or a discrete sine transform of the data block. The coefficient matrix 112 comprises a plurality of coefficients 116. These coefficients 116 resulting from the discrete frequency transformation describe frequency components of the original data block when decomposed into a finite sum of weighted trigonometric functions with different frequencies. In the case of a discrete cosine transform, the corresponding trigonometric functions are cosine functions. In the case of a discrete sine transform, the corresponding trigonometric functions are sine functions.

A discrete cosine transform is a real-valued, discrete, linear, orthogonal transform that transforms a time-discrete signal in the case of a time signal from a time domain to a frequency domain or a space-discrete signal in the case of a spatial signal from a space domain to the frequency domain. A discrete sine transform is also a real-valued, discrete, linear, orthogonal transform that transforms a time-discrete signal in the case of a time signal from a time domain into a frequency domain or a spatially discrete signal in the case of a spatial signal from a spatial domain into the frequency domain.

A discrete frequency transformation, for example a discrete cosine or sine transform, maps a discrete real-valued input signal in the form of a data block, for example in the spatial or time domain, with N data elements x[n] to a discrete real-valued output signal in the form of a coefficient matrix with N coefficients C[n] in the frequency domain, i.e., x[n]=x₀, . . . , xₙ₋₁→C[n]=C(0), . . . , C(n−1).

In the case of a cosine transform, for example, a discrete cosine transform of the form

$$C ( k ) = {\sum }_{n = 0}^{N - 1} {x}_{n} cos [ \frac{π}{N} ( n + \frac{1}{2} ) k ]$$

with k=0, . . . , N−1 is used for a data block of a discrete linear signal comprising N data elements. This cosine transform is even at the beginning at x_{-1/2} and even at the end at X_{N-1/2} with respect to its boundary values. The inverse cosine transform has, for example, the form

$${x}_{n} = \frac{2}{N} \{ \frac{1}{2} C ( 0 ) + {\sum }_{k = 1}^{N - 1} C ( k ) cos [ \frac{π}{N} k ( n + \frac{1}{2} ) ] \}$$

$$with n = 0 , … , N - 1.$$

An extension to multiple dimensions may be achieved, for example, by a multidimensional application. For example, a two-dimensional data block of size N₁×N₂ may be transformed by applying the cosine transform column-wise or row-wise, for example with a discrete cosine transform of the form

$$C ( {k}_{1} , {k}_{2} ) = {\sum }_{{n}_{1} = 0}^{{N}_{1} - 1} {\sum }_{{n}_{2} = 0}^{{N}_{2} - 1} {x}_{{n}_{1} , {n}_{2}} cos [ \frac{π}{{N}_{1}} ( {n}_{1} + \frac{1}{2} ) {k}_{1} ] cos [ \frac{π}{{N}_{2}} ( {n}_{2} + \frac{1}{2} ) {k}_{2} ]$$

with k₁=0, . . . , N₁−1 and k₂=0, . . . , N₂−1. The inverse cosine transform has, for example, the form

$${x}_{{n}_{1} , {n}_{2}} = \frac{2}{N} \{ \frac{1}{4} C ( 0 , 0 ) + {\sum }_{{k}_{1} = 0}^{{N}_{1} - 1} {\sum }_{{k}_{2} = 0}^{{N}_{2} - 1} C ( {k}_{1} , {k}_{2} ) cos [ \frac{π}{{N}_{1}} {k}_{1} ( {n}_{1} + \frac{1}{2} ) ] cos [ \frac{π}{{N}_{2}} {k}_{2} ( {n}_{2} + \frac{1}{2} ) ] \}$$

$$with {n}_{1} = 0 , … , {N}_{1} - 1 and {n}_{2} = 0 , … , {N}_{2} - 1.$$

In the case of a sine transform, for example, a discrete sine transform of the form

$$C ( k ) = {\sum }_{n = 0}^{N = 1} {x}_{n} sin [ \frac{π}{N} ( n + \frac{1}{2} ) ( k + 1 ) ]$$

with k=0, . . . , N−1 is used for a data block of a discrete linear signal comprising N data elements. This sine transform is odd at the beginning at x_{-1/2} and even at the end at X_{N-1/2} with respect to its boundary values. The inverse sine transform has, for example, the form

$${x}_{n} = \frac{{( - 1 )}^{n}}{2} C ( N - 1 ) + {\sum }_{k = 0}^{N - 2} C ( k ) sin [ \frac{π}{N} ( k + 1 ) ( n + \frac{1}{2} ) ]$$

$$with n = 0 , … , N - 1.$$

An extension to multiple dimensions may be achieved, for example, by a multidimensional application. For example, a two-dimensional data block of size N₁×N₂ may be transformed by applying the sine transform column by column or row by row, for example with a discrete sine transform of the form

$$C ( {k}_{1} , {k}_{2} ) = {\sum }_{{n}_{1} = 0}^{{N}_{1} - 1} {\sum }_{{n}_{2} = 0}^{{N}_{2} - 1} {x}_{{n}_{1} , {n}_{2}} sin [ \frac{π}{{N}_{1}} ( {n}_{1} + \frac{1}{2} ) ( {k}_{1} + 1 ) ] sin [ \frac{π}{{N}_{2}} ( {n}_{2} + \frac{1}{2} ) ( {k}_{2} + 1 ) ]$$

with k₁₌₀, . . . , N₁−1 and k₂=0, . . . , N₂−1. The inverse sine transform has, for example, the form

$${x}_{{n}_{1} , {n}_{2}} = \frac{{( - 1 )}^{{n}_{1}} {( - 1 )}^{{n}_{2}}}{2 N} C ( {N}_{1} - 1 , {N}_{2} - 1 ) + \frac{2}{N} {\sum }_{{k}_{1} = 0}^{{N}_{1} - 2} {\sum }_{{k}_{2} = 0}^{{N}_{2} - 2} C ( {k}_{1} , {k}_{2} ) sin [ \text{} \frac{π}{{N}_{1}} ( {k}_{1} + 1 ) ( {n}_{1} + \frac{1}{2} ) ] sin [ \frac{π}{{N}_{2}} ( {k}_{2} + 1 ) ( {n}_{2} + \frac{1}{2} ) ]$$

$$with {n}_{1} = 0 , … , {N}_{1} - 1 and {n}_{2} = 0 , … , {N}_{2} - 1 .$$

A size of the coefficient matrix 112 corresponds, for example, to a size of the data block to be transformed. FIG. 5 shows an exemplary two-dimensional coefficient matrix 112 with, for example, 8×8 coefficients, which results from a discrete frequency transformation of a two-dimensional data block with, for example, 8×8 data elements. The coefficients 116 of the coefficient matrix 112 are assigned to different frequencies or rather describe different frequency components of the underlying data block.

FIG. 6 shows an exemplary arrangement of the coefficients 116 for an exemplary coefficient matrix 112. An N×N coefficient matrix comprises N² coefficients 116 C(k₁,k₂) with k₁=0, . . . , N−1 and k₂=0, . . . , N−1. In principle, the further to the right and the further down a coefficient 116 is arranged in the coefficient matrix 112, the higher the respective frequency.

For example, the coefficients 116 of the coefficient matrix 112 may be assigned to a low frequency range 118, a medium frequency range 120, and/or a high frequency range 122. For example, the coefficient matrix 112 comprises coefficients 116 of a low frequency range 118, which are assigned to low frequencies. For example, the coefficient matrix 112 comprises coefficients 116 of a medium frequency range 120, which are assigned to medium frequencies. For example, the coefficient matrix 112 comprises coefficients 116 of a high frequency range 122, which are assigned to high frequencies.

In the case of an 8×8 coefficient matrix, as shown in FIG. 5, the low frequency range 118 comprises, for example, the coefficients C(0,0) to C(0,4), C(1,0) to C(1,3), C(2,0) to C(2,2), C(3,0) to C(3,1), and C(4,0). The medium frequency range 120 comprises, for example, the coefficients C(0,5) to C(0,7), C(1,4) to C(1,7), C(2,3) to C(2,7), C(3,2) to C(3,6), C(4,1) to C(4,5), C(5,0) to C(5,4), C(6,0) to C(6,3), and C(7,0) to C(7,2). The high frequency range 122 comprises, for example, the coefficients C(3,7), C(4,6) to C(4,7), C(5,5) to C(5,7), C(6,4) to C(6,7), and C(7,3) to C(7,7).

Alternatively, in the case of an 8×8 coefficient matrix, the low frequency range 118 comprises, for example, the coefficients C(0,0) to C(0,3), C(1,0) to C(1,2), C(2,0) to C(2,1), and C(3,0). The medium frequency range 120 comprises, for example, the coefficients C(0,4) to C(0,7), C(1,3) to C(1,7), C(2,2) to C(2,7), C(3,1) to C(3,7), C(4,0) to C(4,6), C(5,0) to C(5,5), C(6,0) to C(6,4), and C(7,0) to C(7,3). The high frequency range 122 comprises, for example, the coefficients C(4,7), C(5,6) to C(5,7), C(6,5) to C(6,7), and C(7,4) to C(7,7).

Alternatively, in the case of an 8×8 coefficient matrix, the low frequency range 118 comprises, for example, the coefficients C(0,0) to C(0,2), C(1,0) to C(1,1), and C(2,0). The medium frequency range 120 comprises, for example, the coefficients C(0,3) to C(0,7), C(1,2) to C(1,7), C(2,1) to C(2,7), C(3,0) to C(3,7), C(4,0) to C(4,7), C(5,0) to C(5,6), C(6,0) to C(6,5), and C(7,0) to C(7,4). The high frequency range 122 comprises, for example, the coefficients C(5,7), C(6,6) to

C(6,7), and C(7,5) to C(7,7).

In the case of an N×N coefficient matrix, where N is an even natural number, the low frequency range 118 comprises, for example, the coefficients C(0,0) to C(0,N/2), C(1,0) to C(1,N/2−1), . . . , C(N/2−1,0) to C(N/2−1,1), and C(N/2,0). The medium frequency range 120 comprises, for example, the coefficients C(0,N/2+1) to C(0,N−1), C(1,N/2) to C(1,N−1), . . . , C(N−2,0) to C(N−2,N/2−1) and C(N−1,0) to C(N−1,N/2−2). The high frequency range 122 comprises, for example, the coefficients C(N/2−1, N−1), C(N/2,N−2) to C(N/2,N−1), . . . , C(N−2,N/2−1) to C(N−2,N−1), and C(N−1,N/2−2) to C(N−1,N−1).

In the case of an N×N coefficient matrix, where N is an even natural number, the low frequency range 118 comprises, for example, the coefficients C(0,0) to C(0,N/2−1), C(1,0) to C(1,N/2−2), . . . , C(N/2−2,0) to C(N/2−2,1), and C(N/2−1,0). The medium frequency range 120 comprises, for example, the coefficients C(0,N/2) to C(0,N−1), C(1,N/2−1) to C(1,N−1), . . . , C(N−2,0) to C(N−2,N/2) and C(N−1,0) to C(N−1,N/2−1). The high frequency range 122 comprises, for example, the coefficients C(N/2, N−1), C(N/2+1,N−2) to C(N/2+1,N−1), . . . , C(N−2,N/2) to C(N−2,N−1), and C(N−1,N/2−1) to C(N−1,N−1).

In the case of an N×N coefficient matrix, where N is an even natural number, the low frequency range 118 comprises, for example, the coefficients C(0,0) to C(0,N/2−2), C(1,0) to C(1,N/2−3), . . . , C(N/2−3,0) to C(N/2−3,1), and C(N/2−2,0). The medium frequency range 120 comprises, for example, the coefficients C(0,N/2−1) to C(0,N−1), C(1,N/2−2) to C(1,N−1), . . . , C(N−2,0) to C(N−2,N/2+1) and C(N−1,0) to C(N−1,N/2). The high frequency range 122 comprises, for example, the coefficients C(N/2+1, N−1), C(N/2+2,N−2) to C(N/2+2,N−1), . . . , C(N−2,N/2+1) to C(N−2,N−1) and C(N−1,N/2) to C(N−1,N−1).

In the case of an N×N coefficient matrix, where N is an odd natural number, the low frequency range 118 comprises, for example, the coefficients C(0,0) to C(0, (N+1)/2−1), C(1,0) to C(1, (N+1)/2−2), . . . , C((N+1)/2−2,0) to C((N+1)/2−2,1), and C((N+1)/2−1,0). The medium frequency range 120 comprises, for example, the coefficients C(0, (N+1)/2) to C(0,N−1), C(1, (N+1)/2−1) to C(1,N−1), . . . , C(N−2,0) to C(N−2, (N−1)/2−1) and C(N−1,0) to C(N−1, (N−1)/2−2). The high frequency range 122 comprises, for example, the coefficients C((N+1)/2−2, N−1), C((N+1)/2−1,N−2) to C((N+1)/2−1,N−1), . . . , C(N−2, (N−1)/2) to C(N−2,N−1), and C(N−1, (N−1)/2−1) to C(N−1,N−1).

In the case of an N×N coefficient matrix, where N is an odd natural number, the low frequency range 118 comprises, for example, the coefficients C(0,0) to C(0, (N−1)/2−1), C(1,0) to C(1, (N−1)/2−2), . . . , C((N−1)/2−2,0) to C((N−1)/2−2,1), and C((N−1)/2−1,0). The medium frequency range 120 comprises, for example, the coefficients C(0, (N−1)/2) to C(0,N−1), C(1, (N−1)/2−1) to C(1,N−1), . . . , C(N−2,0) to C(N−2, (N−1)/2) and C(N−1,0) to C(N−1, (N−1)/2−1). The high frequency range 122 comprises, for example, the coefficients C((N−1)/2−2, N−1), C((N−1)/2−1,N−2) to C((N+1)/2−1,N−1), . . . , C(N−2, (N−1)/2+1) to C(N−2,N−1), and C(N−1, (N−1)/2) to C(N−1,N−1).

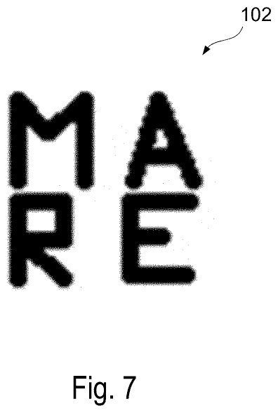

FIG. 7 shows an example of a digital watermark 102 in the form of an image, which is provided, for example, as an image file. This is, for example, a black-and-white image. The values of the individual pixels of the watermark 102 may be either white or black. In the case of a binary image, the pixels are assigned pixel values of 1 or 0 for white and black, for example. In this case, the bit sequences to be assigned are, for example, individual bits, each of which defines a pixel value. For example, the black-and-white image may be a black-and-white image that uses grayscale formatting. In this case, only the pixel values 255 for white and 0 for black are used, for example. In this case, the bit sequences to be assigned are, for example, sequences of 8 bits, each of which defines a pixel value.

For example, the size of the watermark 102, i.e., the number of pixels, corresponds to the size of the groups of coefficient matrices, i.e., the number of coefficient matrices in the groups. Consequently, each pixel of the image, i.e., each bit sequence, may be assigned a coefficient matrix per complete group. If the coefficient matrices cannot be divided into groups without remainder, an incomplete residual group may remain. For example, the coefficient matrices may be assigned to pixels of the image in this residual group, but not every pixel is assigned a coefficient matrix. This means that the watermark 102 is embedded incompletely in the incomplete residual group, for example.

To embed the watermark 102, the coefficient matrices are changed in the individual groups of coefficient matrices. The change in the coefficient matrices depends on the value of the assigned pixel or rather the corresponding assigned bit sequence of the watermark. In this way, the watermark may be embedded in each group of the plurality of groups and thus in the file to be secured.

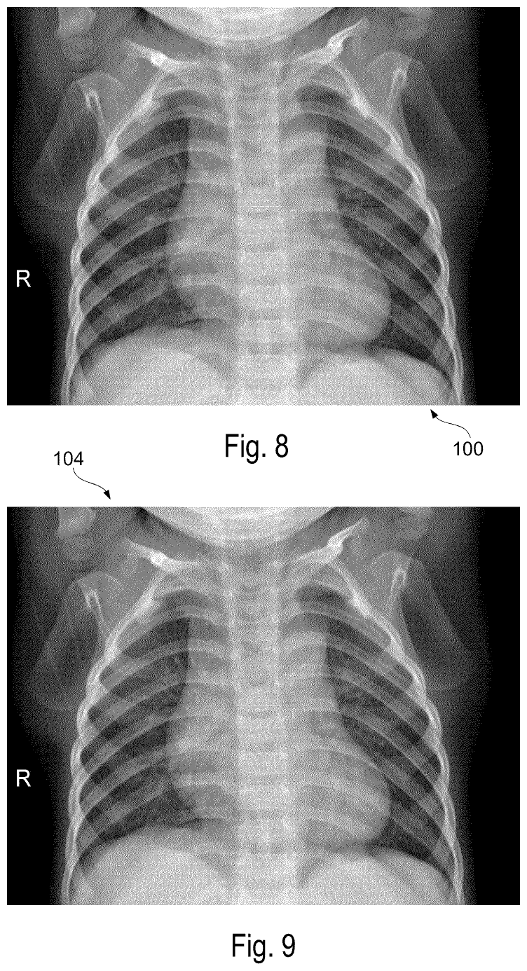

FIGS. 8 and 9 show two example image files 100, 104, each in the form of a chest X-ray image. The images are, for example, the same chest X-ray image, with the only difference between the images being that the image file 100 shown in FIG. 8 is the unmodified original image file, while the modified image file 104 has the watermark 102 from FIG. 7 embedded in it. The chest X-ray image of the two example image files 100, 104 may, for example, represent an X-ray image of a chest. The image files 100, 104 may, for example, be in the form of JPEG files. When viewing the two images visually, for example, no difference between them may be detected.

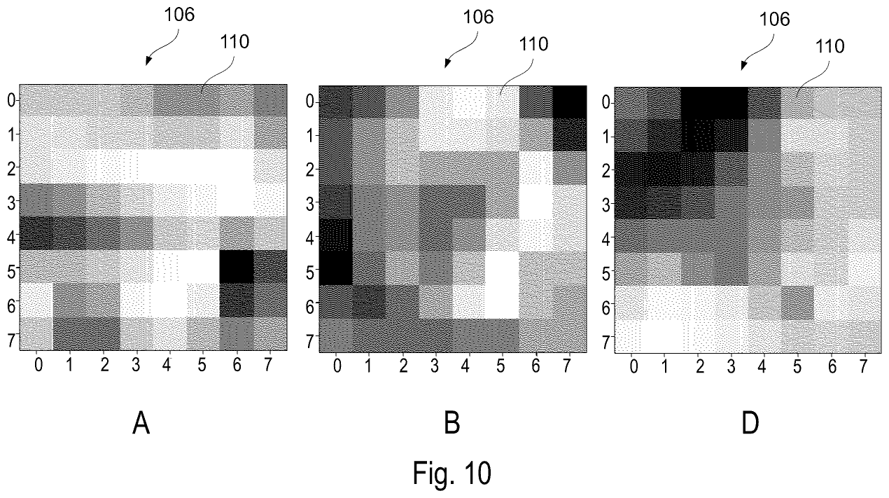

FIG. 10 shows three exemplary data blocks 106 of a file to be secured in the form of an image file. The three data blocks are numbered with the letters A, B, and C. The underlying image file is, for example, a grayscale image. The three data blocks 106 are therefore also grayscale images or rather image sections of the underlying grayscale image. The corresponding data blocks 106 each have a size of 8×8 pixels, for example.

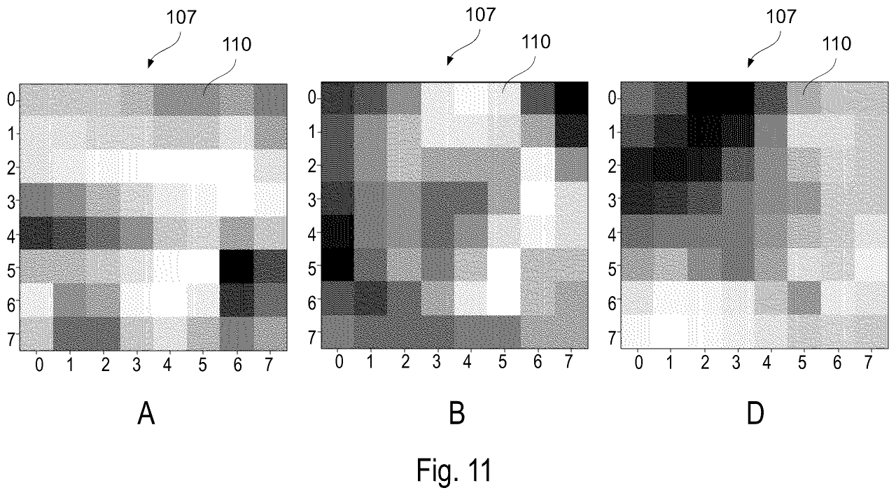

FIG. 11 shows three exemplary modified data blocks 107 of a secured file. These three modified data blocks 107 correspond to the three data blocks 106 from FIG. 10, in each of which a pixel of a watermark has been embedded. In the data blocks 107 shown in FIG. 11, the coefficient [0,0] of the assigned coefficient matrix has been changed in each case. This means that the corresponding original data block 106 from FIG. 10 has been transformed into a coefficient matrix by means of discrete cosine transform, and the coefficient [0,0] of the resulting coefficient matrix was changed depending on the pixel of the watermark assigned to the corresponding coefficient matrix or rather the underlying data block 106, and the coefficient matrix changed in this way was transformed back from the frequency space into the image space by means of an inverse discrete cosine transform. The result of this back transformation are the modified data blocks 107 shown in FIG. 11.

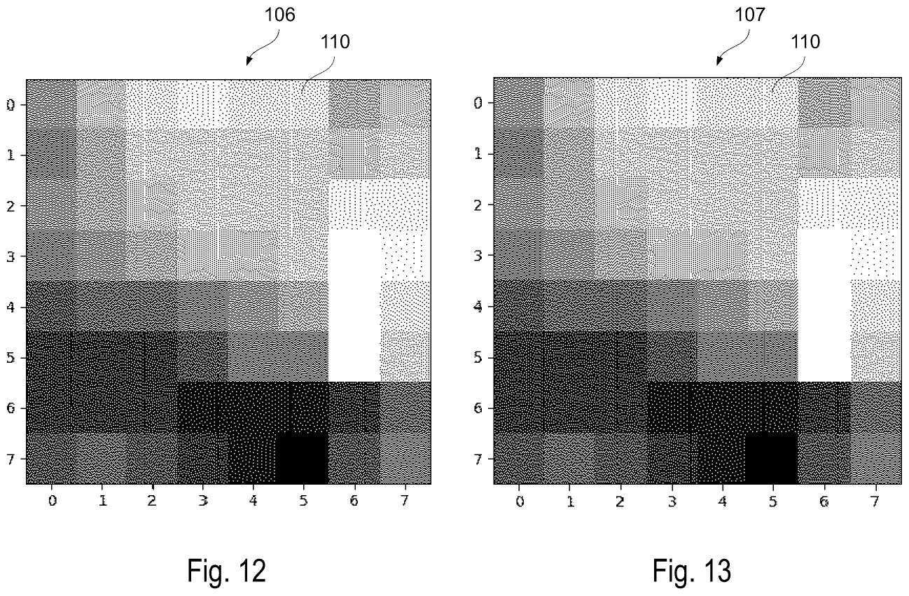

FIGS. 12 and 13 also show an original data block 106 and an assigned modified data block 107, in which a pixel of the watermark has been embedded by modifying the coefficient [0,0] of the assigned coefficient matrix. Changing the coefficient [0,0] of the assigned coefficient matrix causes the brightness of the individual data blocks to change. Thus, the brightness or rather exposure of the individual data blocks or rather image sections is varied depending on the value of the assigned pixel or rather the corresponding assigned bit sequence of the watermark.

FIG. 14 shows an example data block 106 with data elements 108 of a file to be secured in the form of a grayscale image. The data block 106 corresponds to an image section from the grayscale image, for example an 8×8 pixel section. The data elements 108 of the data block 106 specify grayscale values of the corresponding pixels of the image section in the form of bit sequences.

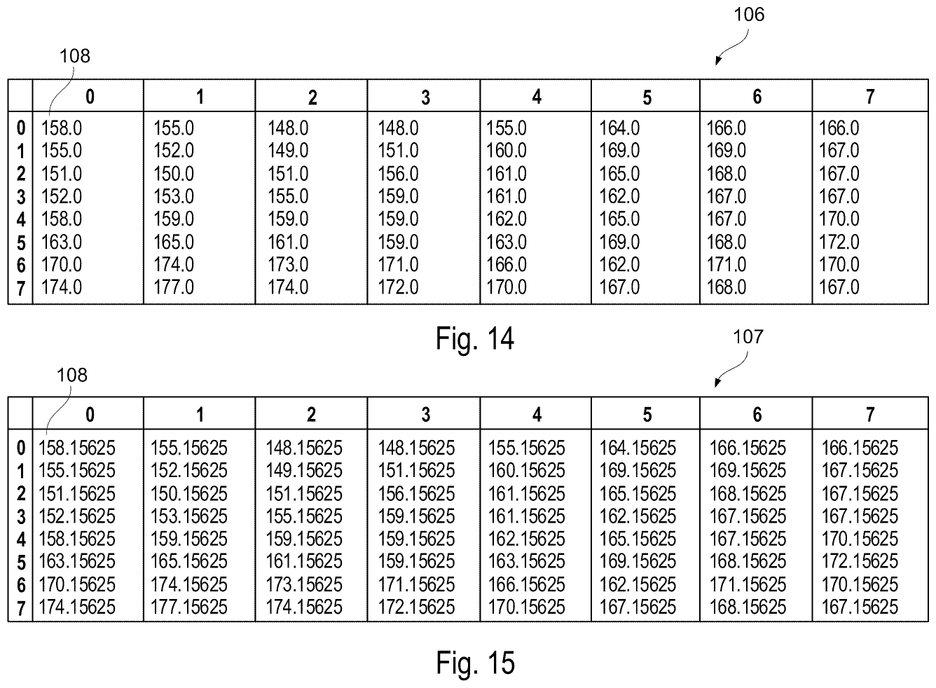

FIG. 15 shows an example of a modified data block 107 of a secured file. This modified data block 107 corresponds to the data block 106 from FIG. 14, in which a pixel of the watermark has been embedded. In the data block 107 shown in FIG. 15, the coefficient [0,0] of the assigned coefficient matrix has been changed. This means that the corresponding original data block 106 from FIG. 14 has been transformed into a coefficient matrix by means of discrete cosine transform, and the coefficient [0,0] of the resulting coefficient matrix was changed depending on the pixel of the watermark assigned to the corresponding coefficient matrix or rather the underlying data block 106, and the coefficient matrix changed in this way was transformed back from the frequency space into the image space by means of an inverse discrete cosine transform. The result of this back transformation is the modified data blocks 107 shown in FIG. 15. The change in the coefficient [0,0] of the assigned coefficient matrix results in a uniform change in the values of the data elements 108 of the modified data block 107. In the example shown, a uniform offset of 0.15625 is added to each of the data elements 108 of the modified data block 107.

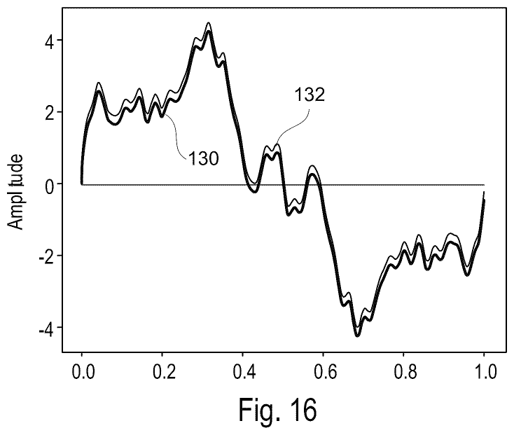

FIG. 16 shows exemplary amplitude distributions 130, 132 for normalized pixel values of a data block of an original file and a modified data block of a modified file. In the modified data block, the coefficient [0,0] of the assigned coefficient matrix was changed depending on the pixel value to be embedded. This results in a uniform change in the values of the data elements of the modified data block or rather in an offset of the amplitude distribution 132 of the modified data block relative to the amplitude distribution of the original data block. The form of the two amplitude distributions 130, 132 is identical. They are merely shifted relative to each other by an offset.

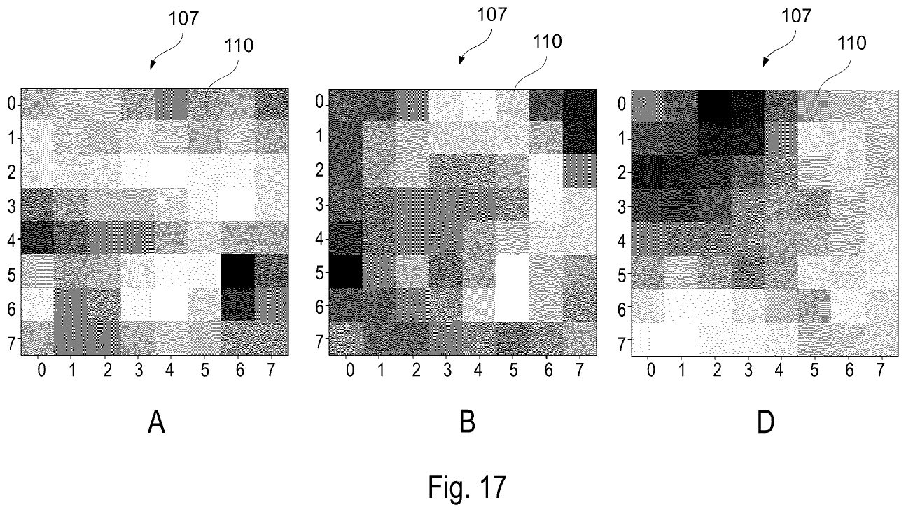

FIG. 17 shows three further exemplary modified data blocks 107 of a secured file. These three modified data blocks 107 of FIG. 17 also correspond to the three data blocks 106 from FIG. 10, in each of which a pixel of a watermark was embedded. However, in the data blocks 107 shown in FIG. 17, the coefficient [4,4] of the assigned coefficient matrix has been changed in each case. This means that the corresponding original data block 106 from FIG. 10 has been transformed into a coefficient matrix by means of discrete cosine transform, and the coefficient [4,4] of the resulting coefficient matrix was changed depending on the pixel of the watermark assigned to the corresponding coefficient matrix or rather the underlying data block 106, and the coefficient matrix changed in this way was transformed back from the frequency space into the image space by means of an inverse discrete cosine transform. The result of this back transformation are the modified data blocks 107 shown in FIG. 17. Due to the change in the coefficient [4,4], the pixel values of the pixels 110 within the data blocks 107 are changed relative to each other, i.e., all pixels 110 are changed, but to different degrees.

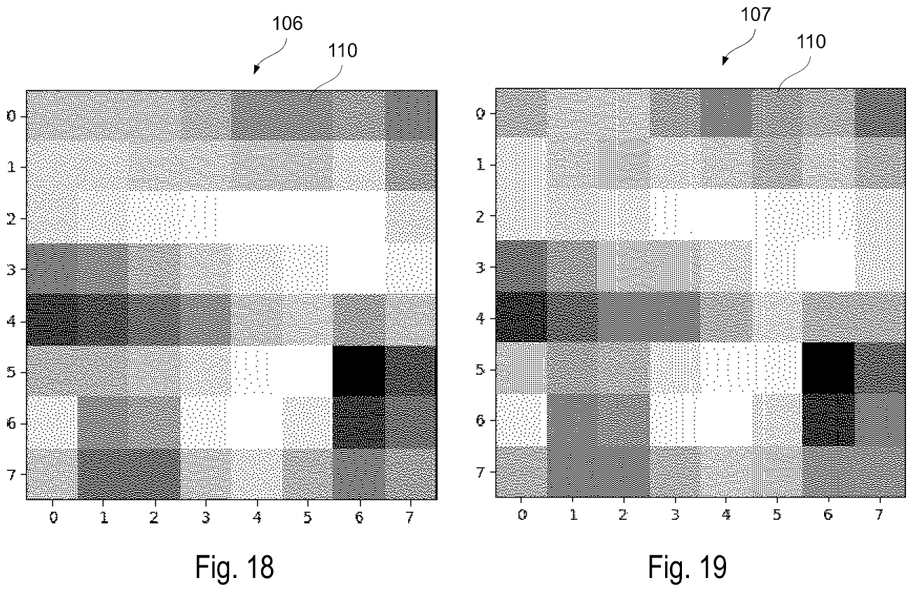

FIGS. 18 and 19 show an original data block 106 and a corresponding modified data block 107, in which a pixel of the watermark has been embedded by also changing the coefficient [4,4] of the corresponding coefficient matrix. A change in the coefficient [4,4] of the assigned coefficient matrix causes the pixel values of the pixels 110 within the data blocks 107 to change relative to each other. This results in a change in the distribution of the pixel values within the data blocks.

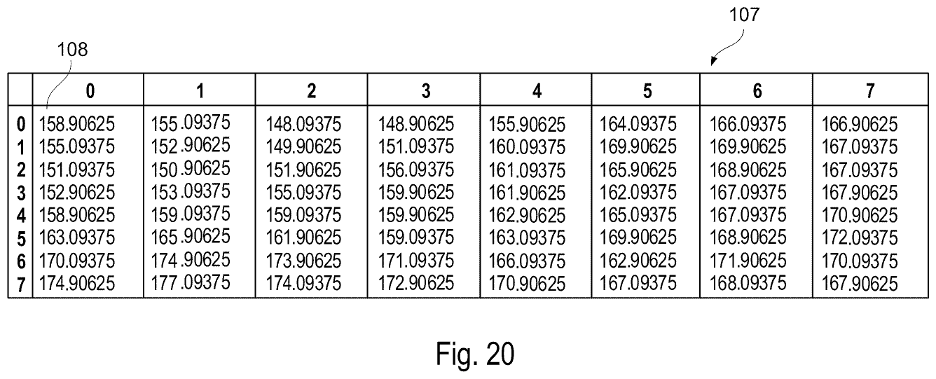

FIG. 20 shows an example of a modified data block 107 of a secured file. This modified data block 107 corresponds to the data blocks 106 from FIG. 14, in which a pixel of the watermark was embedded. In the data block 107 shown in FIG. 20, the coefficient [4,4] of the assigned coefficient matrix has been modified. This means that the corresponding original data block 106 from FIG. 14 has been transformed into a coefficient matrix by means of discrete cosine transform, and the coefficient [4,4] of the resulting coefficient matrix was changed depending on the pixel of the watermark assigned to the corresponding coefficient matrix or rather the underlying data block 106, and the coefficient matrix changed in this way was transformed back from the frequency space into the image space by means of an inverse discrete cosine transform. The result of this back transformation is the modified data blocks 107 shown in FIG. 20. The change in the coefficient [4,4] of the assigned coefficient matrix results in a change in the pixel values, i.e., the data elements 108 within the data block 107 relative to each other. Consequently, the distribution of the pixel values within the data block 107 changes relative to the underlying data block 106 from FIG. 14.

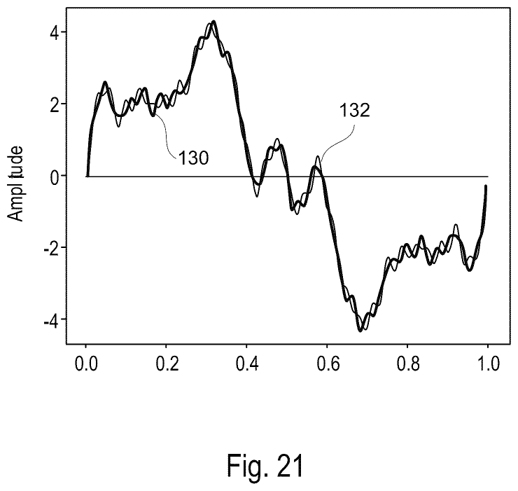

FIG. 21 shows exemplary amplitude distributions 130, 132 for normalized pixel values of a data block of an original file and a modified data block of a modified file. In the modified data block, the coefficient [4,4] of the assigned coefficient matrix was changed depending on the pixel value to be embedded. This results in a change in the distribution of the pixel values and thus in a change in the amplitudes. There is no offset. Rather, the curves of the two amplitude distributions 130, 132 differ from each other.

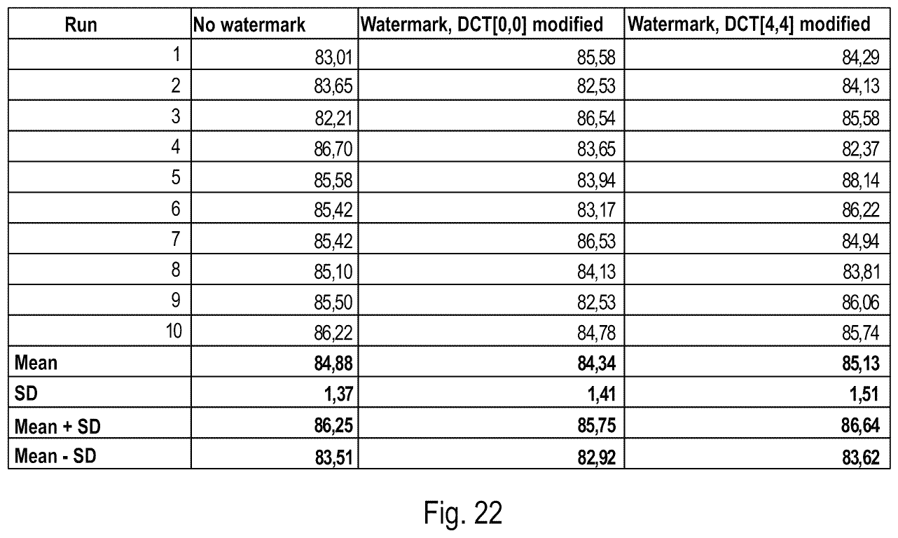

FIG. 22 shows an exemplary overview of an effect of embedding a digital watermark on an analysis of files using a machine learning module. The overview shows the results for a test with a module in the form of a PyTorch ANN model and approximately 6000 chest X-ray images. A training set comprises 5232 chest X-ray images, while a test set comprises 624 images. The module was trained with the training sets to either identify a positive pneumonia finding in the chest X-ray images or to mark them as finding-free. For example, the module is trained to label the chest X-ray images accordingly.

For example, the runtime of a training and test run of the corresponding neural network with all 6,000 chest X-ray images on a conventional notebook was 6 minutes. Embedding the watermark took 13.6 minutes, for example.

Ten complete training and test runs were performed with different compositions of the training and test sets. In one case, chest X-ray images without watermarks were used for the training and test runs. In one case, chest X-ray images with embedded watermarks were used for the training and test runs, whereby the watermark was embedded by changing the coefficients [0,0] in the cosine-transformed coefficient matrices of the chest X-ray images. Finally, chest X-ray images with embedded watermarks were used for the training and test runs, with the watermark being embedded by changing the coefficients [4,4] in the cosine-transformed coefficient matrices of the chest X-ray images.

The overview shows that there are no significant differences in the results for the test sets without watermarks and the results for the test sets with watermarks. The values listed in the overview for the correct assignment of the images show no significant differences for chest X-ray images with and without watermarks. This applies in particular to the mean values of the test runs. If the standard deviation is taken into account, it can be seen that the mean values and thus the results of the test runs correspond within the standard deviations. Consequently, embedding a watermark in the manner described here, for example using a discrete cosine transform, does not have any negative effects on the use of correspondingly modified image files in the course of an analysis with a machine learning module. This means that the correspondingly modified images are suitable for use in the field of machine learning.

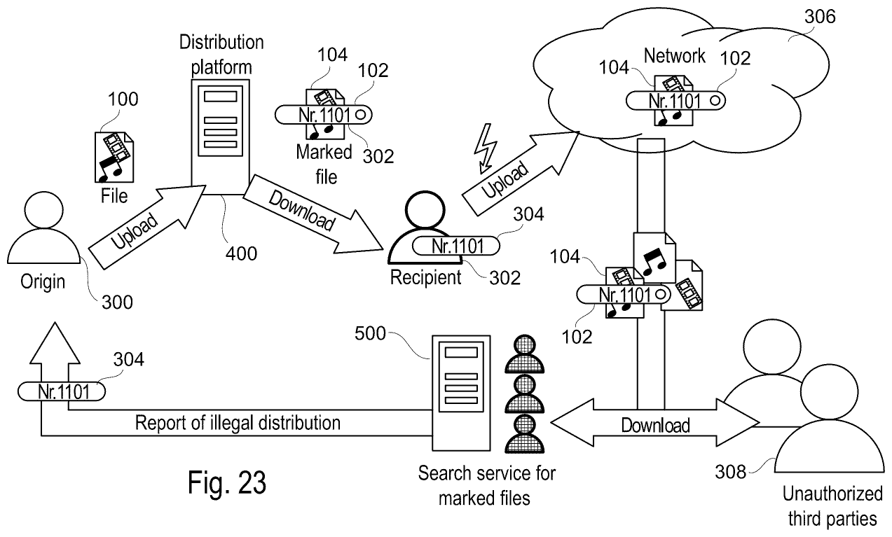

FIG. 23 shows an exemplary system for securing files and identifying the origins of the secured files. A computer device 400 for securing files using digital watermarks receives, for example, a file 100 to be secured. This computer device 400 is, for example, a server. For example, it is a computer device or server of a distribution platform for the corresponding file 100. For example, the file 100 is sent or rather uploaded to the computer device 400 by a rights holder or rather origin. The file 100 is secured by embedding a watermark. For example, the method according to FIG. 1 is used for this purpose. The result is a secured file 104 with an embedded watermark 102. For example, file 104 is secured before it is downloaded. The embedded watermark 102 comprises, for example, a recipient ID 304 of a recipient 302 who requests the download of the secured file 104. The file 104 provided to the recipient 302 for download is thus marked in such a way that it may be clearly assigned to the corresponding recipient 302.

If the recipient 302 subsequently distributes the downloaded file 104 unlawfully, for example by uploading it to a network 306 such as the Internet, the file 104 may be clearly assigned to the recipient 302 on the basis of the watermark 102. For example, file 104 can be downloaded from network 306, so that unauthorized third parties 308 may download file 104 and use it for their own purposes.

For example, a search service for marked files, such as file 104, is set up. This search service comprises, for example, a computer device 500 that is configured to identify the origins of secured files using watermarks. The computer device 500 is configured, for example, to perform similarity comparisons of copies, such as the file 104 downloaded from the network 306, with the original file 104 or the original file 100. For this purpose, the computer device 500 can, for example, use a hashing algorithm for images, in particular the so-called perceptual hashing method, in the case of an image file. These are configured to convert essential visual features of an image into a compact numerical fingerprint or hash. Similar images result in similar hashes, while different images generate significantly different hashes. This enables, for example, a fast and efficient similarity analysis of images.

The computer system 500 can use the watermark to identify the origin of the secured file 104. To do this, the computer system 500 uses, for example, one of the methods shown in FIGS. 2 to 4. Furthermore, the computer system may use the recipient ID 302 comprised in the watermark to identify the recipient 304 who distributed the secured file 104. The computer system 500 may then send the rights holder 300 a notification of the illegal distribution of the secured file 104. In particular, such a notification may comprise the recipient ID 302, which the rights holder 300 can use to identify the recipient 304.

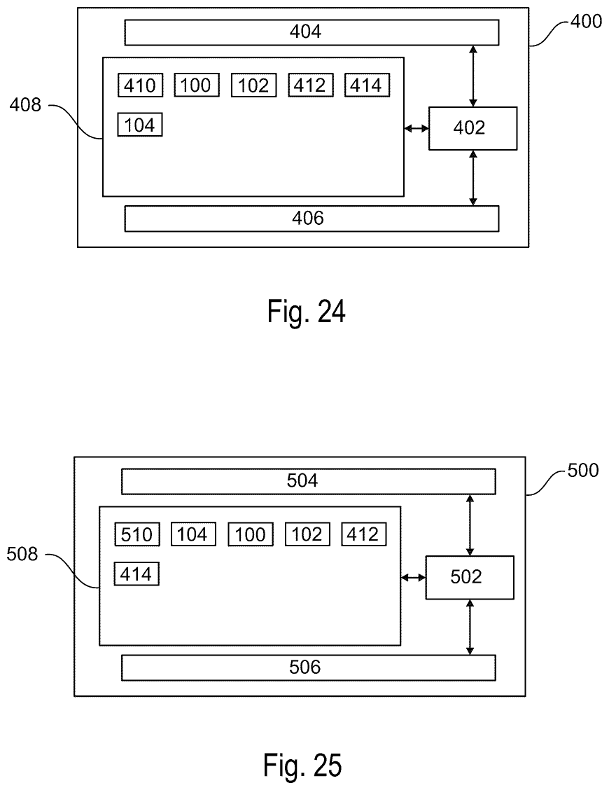

FIG. 24 shows an exemplary computer device 400 for securing a file 100 using a digital watermark 102. The computer device 400 comprises, for example, a hardware interface 404, which may be configured in particular as a communication interface for communication via a network. Via the hardware interface 404, the computer device 400 may, for example, receive the file 100 to be secured and make it available in a secured form, i.e., as a modified file 104 with an embedded watermark 102, for download, for example. Furthermore, the computer device 400 comprises, for example, an optional user interface 406, which enables a user to interact with the computer device 400. In particular, the user interface 406 enables the user to monitor and/or control the securing of the file 100. The user interface 406 may, for example, comprise input and output means such as a display, a touch screen, a keyboard, a mouse, etc.

The computer device 400 shown also comprises a processor unit or computing unit 402 and a memory unit 408. The processor unit 402 may, for example, be an integrated circuit in the form of a microprocessor or a microcontroller in an embedded system. The processor unit 402 shown represents one or more processor units.

The memory unit 408 comprises machine-readable or rather machine-executable program instructions 410. The machine-readable program instructions 410 may enable the processor unit 402 to perform various numerical and computational tasks. The machine-readable program instructions 410 may also enable the processor unit 402 to communicate with other components and/or computer devices via the hardware interface 404 and, if necessary, to control and/or operate them.

The machine-readable program instructions 410 may further be configured to secure a file 100 to be secured using a watermark 102 by embedding the watermark in the file 100 to be secured. For example, the program instructions 410 may be configured to control the processor unit 402 to execute the method shown in FIG. 1 when executed by the processor unit 402. In the course of embedding the watermark in the file 100, the file is transformed, for example, using a discrete frequency transformation, such as a discrete cosine or sine transform. The result of this transformation is a transformed file 412 comprising a plurality of coefficient matrices. These coefficient matrices are changed depending on bit sequences of the watermark 102 to be embedded into the file 100 to be secured. The resulting modified transformed file 414 is transformed back using an inverse discrete frequency transformation, such as an inverse discrete cosine or sine transform. The result is the secured file 104, in which the watermark 102 is embedded multiple times in redundant form.

The embedded watermark 102 indicates, for example, the origin of the file 104. For example, the watermark also indicates a recipient to whom the file 104 is made available.

FIG. 25 shows an exemplary computer device 500 for identifying the origin of a file 104 to be checked using a digital watermark 102. The computer device 500 comprises, for example, a hardware interface 504, which may be configured in particular as a communication interface for communication via a network. Via the hardware interface 504, the computer device 500 can, for example, receive the file 104 to be checked.

Furthermore, the computer device 500 comprises, for example, an optional user interface 506, which enables a user to interact with the computer device 500. In particular, the user interface 506 enables the user to monitor and/or control the checking of the file 104 to be checked. The user interface 506 may, for example, comprise input and output means such as a display, a touch screen, a keyboard, a mouse, etc.

The computer device 500 shown also comprises a processor unit or computing unit 502 and a memory unit 508. The processor unit 502 may, for example, be an integrated circuit in the form of a microprocessor or a microcontroller in an embedded system. The processor unit 502 shown represents one or more processor units.

The memory unit 508 comprises machine-readable or machine-executable program instructions 510. The machine-readable program instructions 510 may enable the processor unit 502 to perform various numerical and computational tasks. The machine-readable program instructions 510 may also enable the processor unit 502 to communicate with other components and/or computer devices via the hardware interface 504 and, if necessary, to control and/or operate them.

The machine-readable program instructions 510 may further be configured to identify the origin of a file 104 to be checked using a digital watermark 102. For example, the program instructions 510 may be configured to control the processor unit 502, when executed by the processor unit 502, to perform one of the methods according to one of FIGS. 2 to 4. In the course of identifying the origin, the file 104 to be checked is transformed, for example, using a discrete frequency transformation, such as a discrete cosine or sine transform. The result of this transformation is a transformed file 414, which comprises a plurality of coefficient matrices in which the watermark 102 is embedded. For example, the watermark 102 may be read, i.e., extracted, from the transformed file 414 based on the values of coefficients of the coefficient matrices, such as whether they are even or odd. Alternatively, a transformed file 412 without an embedded watermark 102 may be generated using a copy of the file 102 that does not comprise a watermark. This transformed file 412 is, for example, the result of a discrete frequency transformation, such as a discrete cosine or sine transform, of file 102. A comparison between files 414 and 412 may be used, for example, to determine the changes in file 414 relative to file 412. The watermark is encoded in these changes, for example.

The extracted watermark 102 indicates, for example, the origin of the file 104. For example, the watermark also indicates a recipient to whom the file 104 was made available.

Although the invention is illustrated and described in detail in the drawings and the foregoing description, this illustration and description should be considered exemplary and not limiting; the invention is not limited to the disclosed embodiments.

Other variations of the disclosed examples may be understood and practiced by those skilled in the art in practicing the claimed invention based on the drawings, description, and appended claims. In the claims, the word “comprising” does not exclude other elements or steps, and the indefinite article “a” does not exclude a plurality. The mere fact that certain features are mentioned in different dependent claims does not mean that a combination of these features cannot be advantageous. Any reference signs in the claims should not be interpreted as limiting the scope of protection.

A single processor or other unit may perform the functions of several elements mentioned in the claims. A computer program may be stored/distributed on a suitable medium, for example on an optical storage medium or a solid-state medium, which is supplied together with or as part of other hardware, but it may also be distributed in other forms, for example via the Internet or other wired or wireless telecommunications systems.

As those skilled in the art will understand, aspects of the present invention may be embodied in the form of an apparatus, a method, or a computer program product. Accordingly, aspects of the present invention may take the form of a pure hardware variant, a pure software variant (including firmware, resident software, microcode, etc.), or a variant combining software and hardware aspects, which may be generally referred to herein as a “circuit”, “module”, or “system”. Furthermore, aspects of the present invention may take the form of a computer program product embodied in one or more computer-readable media having computer-executable code embodied thereon.

Any combination of one or more computer-readable media may be used. The computer-readable medium may be a computer-readable signal medium or a computer-readable storage medium. A “computer-readable storage medium”, as used herein, comprises any tangible storage medium that can store instructions executable by a processor or computing system of a computer unit. The computer-readable storage medium may be referred to as a computer-readable non-transitory storage medium. The computer-readable storage medium may also be referred to as a tangible computer-readable medium. In some embodiments, a computer-readable storage medium may also be capable of storing data that is accessible to the processor or computing system of the computer unit. Examples of computer-readable storage media comprise, but are not limited to: a floppy disk, a magnetic hard disk drive, a solid-state hard disk, flash memory, a USB stick, random access memory (RAM), read-only memory (ROM), an optical disk, a magneto-optical disk, and the register file of the processor or computing system. Examples of optical disks comprise compact disks (CD) and digital versatile disks (DVD), such as CD-ROM, CD-RW, CD-R, DVD-ROM, DVD-RW, or DVD-R disks. The term “computer-readable storage medium” also refers to various types of recording media that the computer unit can access via a network or communication link. For example, data may be accessed via a modem, the Internet, or a local area network. Computer-readable or computer-executable code embodied on a computer-readable medium may be transmitted via any suitable medium, including, but not limited to, wireless transmission, wired transmission, fiber optic cable, radio frequency transmission, etc., or via a suitable combination of the foregoing media.

A computer-readable signal medium may comprise a propagating data signal embodying computer-executable code therein, for example in a baseband or as part of a carrier wave. Such a transmitted signal may take any form, including, but not limited to, electromagnetic or optical signals, or any suitable combination thereof. A computer-readable signal medium may be any computer-readable medium that is not a computer-readable storage medium and that may convey, disseminate, or transport a program for use by or in conjunction with an instruction execution system, apparatus, or device.

An example of a computer-readable storage medium is a “computer memory”, “storage unit”, or “storage”. A computer memory is any storage that can be directly accessed by a processor or computing system.

A “processor system”, “processor unit”, “computing system”, or “computing unit”, as used herein, comprises an electronic component capable of executing a program or machine-executable instruction or computer-executable code. References to the processor system or computing system that comprises an example “a processor system” or “a computing system” should be understood to mean that the example may comprise more than one processor system, processor unit, computing system, computing unit, or processor core. The processor system or computing system may, for example, be a multi-core processor. A processor system, processor unit, computing system, or computing unit may also refer to a collection of processor units or computing units within a single computer system or distributed across multiple computer systems. The term “processor system”, “processor unit”, “computing system”, or “computing unit” should also be interpreted as possibly referring to a collection or network of computing devices, each of which comprises a processor or computing system. The machine-executable code or instructions may be executed by multiple computer systems or processors located within the same computing device or even distributed across multiple computing devices.

Machine-readable or machine-executable instructions or computer-readable code or computer-executable code may comprise instructions or a program that causes a processor or other computing system to perform an aspect of the present invention. Computer-executable code for performing operations for aspects of the present invention may be written in any combination of one or more programming languages, including an object-oriented programming language such as Java, Smalltalk, C++, or similar, and conventional procedural programming languages such as the programming language “C” or similar programming languages, and compiled into machine-executable instructions. In some cases, the computer-executable code may be in the form of a high-level language or in precompiled form and used in conjunction with an interpreter that generates the machine-executable instructions during operation. In other cases, the machine-executable instructions or computer-executable code may be in the form of programming for programmable logic gate arrays.

The executable computer code may be executed entirely on the user's computer unit, partially on the user's computer unit, as a standalone software package, partially on the user's computer unit and partially on a remote computer unit, or entirely on the remote computer unit or server. In the latter case, the remote computer unit may be connected to the user's computer unit via any network, including a local area network (LAN) or a wide area network (WAN), or the connection may be established with an external computer unit (for example, via the Internet with the help of an Internet service provider).

Aspects of the present invention are described with reference to flowchart illustrations and/or block diagrams of methods, devices (systems), and computer program products according to embodiments of the invention. It is understood that each block or part of the blocks of the flowchart, illustrations, and/or block diagrams may be implemented by computer program instructions in the form of computer-readable or computer-executable code, if applicable. It is further understood that combinations of blocks in different flowcharts, illustrations, and/or block diagrams may be combined if they are not mutually exclusive. These computer program instructions may be provided to a computing system of a general-purpose computer, a special-purpose computer, or another programmable data processing device to create a machine so that the instructions executed via the computing system of the computer or another programmable data processing device provide means for implementing the functions/actions specified in the flowchart and/or block diagram block or blocks.

These machine-executable instructions or computer program instructions may also be stored in a computer-readable medium that can instruct a computer, other programmable data processing device, or other apparatus to function in a specific manner, such that the instructions stored in the computer-readable medium produce a manufactured article containing instructions that perform the function/action indicated in the flowchart and/or the block diagram block or blocks.

The machine-readable or machine-executable instructions or computer program instructions may also be loaded onto a computer, another programmable data processing device, or other devices to cause a series of process steps to be executed on the computer, another programmable device, or other devices to produce a computer-implemented process, so that the instructions executed on the computer or other programmable device provide processes for implementing the functions/actions specified in the flowchart and/or block diagram block or blocks.

A “user interface”, as used herein, is an interface that allows a user or operator to interact with a computer or computer system. A “user interface” may also be referred to as a “human interface device”. A user interface may provide information or data to the user and/or receive information or data from the user. A user interface may enable the computer to receive input from the user and provide output from the computer to the user. In other words, the user interface may enable a user to control or manipulate a computer, and the interface may enable the computer to display the effects of the user's control or manipulation. Displaying data or information on a display or graphical user interface is an example of providing information to a user. Receiving data via a keyboard, mouse, trackball, touchpad, pointing stick, graphics tablet, joystick, gamepad, webcam, headset, pedals, wired glove, remote control, and accelerometer are all examples of user interface components that enable the reception of information or data from a user.

A “hardware interface”, as used herein, comprises an interface that enables the processor system or computing system of a computer unit or computer system to interact with and/or control an external computer device and/or external apparatus. A hardware interface may enable a computer unit to send control signals or commands to an external computer device and/or apparatus. A hardware interface can also enable a computer unit to exchange data with an external data processing system and/or device. Examples of hardware interfaces comprise: a universal serial bus, an IEEE 1394 port, a parallel port, an IEEE 1284 port, a serial port, an RS-232 port, an IEEE 488 port, a Bluetooth connection, a wireless local area network connection, a TCP/IP connection, an Ethernet connection, a control voltage interface, a MIDI interface, an analog input interface, and a digital input interface.

A “display”, “screen”, or “display device”, as used herein, comprises an output device or user interface suitable for displaying images or data. A display can output visual, acoustic, and/or tactile data. Examples of a display comprise, but are not limited to: a computer monitor, a television screen, a touch screen, a tactile electronic display, a Braille display, cathode ray tube (CRT), memory tube, bistable display, electronic paper, vector display, flat screen, vacuum fluorescent display (VF display), light-emitting diode (LED) display, electroluminescent display

(ELD), plasma display panel (PDP), liquid crystal display (LCD), organic light-emitting diode display (OLED), projector, and head-mounted display.

### LIST OF REFERENCE SIGNS

100 digital file to be secured
102 digital watermark
104 modified digital file
106 data block
107 modified data block
108 data element
110 pixel
112 coefficient matrix
114 modified coefficient matrix
116 coefficient
118 low frequency range
120 medium frequency range
122 high frequency range
130 amplitude
132 amplitude
300 origin
302 recipient
304 recipient ID
306 network
308 unauthorized third parties
400 computer device
402 processor unit
404 hardware interface
406 user interface
408 memory unit
410 machine-readable program instructions
412 transformed file
414 modified transformed file
500 computer device
508 memory unit
510 machine-readable program instructions

1. A computer-implemented method for securing a file using a digital watermark, the method comprising:
receiving the file to be secured;
receiving the watermark to be embedded in the file to be secured, which is configured as a proof of origin of the file to be secured and identifies an origin assigned to the file to be secured, wherein the watermark comprises a plurality of bit sequences,
dividing the entire file to be secured into a plurality of data blocks,
transforming and grouping the data blocks into a plurality of groups, wherein the transforming comprises transforming the data blocks, in each case, into a coefficient matrix with a plurality of coefficients of a discrete frequency transformation applied to the corresponding data block, wherein the discrete frequency transformation is one of the following discrete transformations: a discrete cosine transform, a discrete sine transform, wherein a coefficient matrix is assigned to all groups for each bit sequence of the watermark,
embedding the watermark in each group of the plurality of groups, wherein in each group of the plurality of groups, a coefficient per assigned coefficient matrix is changed depending on a value of the bit sequence of the watermark assigned to the corresponding coefficient matrix,
back-transforming the modified coefficient matrices into a modified data block using an inverse discrete frequency transformation applied to the corresponding coefficient matrix,
providing the resulting modified file.

2. The method of claim 1, wherein the plurality of bit sequences comprises one or more identifiers in the form of one or more sets of one or more predetermined bit sequences which frame the watermark and mark a beginning and an end of the watermark.

3. The method of claim 1, wherein within the groups, those coefficients of the coefficient matrices of the corresponding group which are changed depending on the value of the bit sequence of the watermark assigned to the corresponding coefficient matrix are varied according to a predefined first distribution.

4. The method of claim 3, wherein the predefined first distribution is a first random distribution reproducible using the same first initialization data.

5. The method of claim 1, wherein within the groups, a type of change in the coefficients of the coefficient matrices of the corresponding group, which are changed depending on the value of the bit sequence of the watermark assigned to the corresponding coefficient matrix, is varied according to a predefined second distribution.

6. The method of claim 5, wherein the predefined second distribution is a second random distribution reproducible using the same second initialization data.

7. The method of claim 1, wherein the coefficients of the coefficient matrices are assigned to different frequencies, wherein the frequencies are divided into at least frequencies of a low frequency range and a high frequency range, wherein coefficients of the coefficient matrices that are assigned to frequencies of the high frequency range are each excluded from being changed in dependence on the watermark.

8. The method of claim 1, wherein the watermark is further assigned to an intended recipient of the file to be secured and is configured to identify the intended recipient.

9. The method of claim 1, wherein parameters are stored in a register which describe the embedding of the watermark into the file to be secured and are configured to enable checking of the resulting modified file for the presence of the watermark in the corresponding file.

10. The method of claim 1, wherein the modification of the coefficients of the coefficient matrices depending on the bit sequences of the watermark comprises one or more of the following types of modifications: a bit sequence-dependent modification of a bit of the coefficients, bit sequence-dependent selection of a decimal place of the coefficients to be changed, bit sequence-dependent addition and subtraction of a predefined value from the coefficients, bit sequence-dependent rounding up and rounding down of the coefficients, bit sequence-dependent rounding up of the coefficients to even and odd values, bit sequence-dependent rounding down of the coefficients to even and odd values.

11. The method of claim 1, wherein the file to be secured is one of the following types of files: an image file, an audio file, a video file, and/or wherein the watermark is one of the following types: a character string, a text file, an image file, an audio sequence.

12. A computer-implemented method for identifying an origin of a file to be checked using a digital watermark which is embedded multiple times in redundant form in the file using a method according to claim 1 and which indicates the origin to be identified, the method comprising:
receiving the file to be checked,
dividing the file to be checked into a plurality of data blocks,
transforming at least a portion of the data blocks into a coefficient matrix with a plurality of coefficients of a discrete frequency transformation applied to the corresponding data block, wherein the discrete frequency transformation is one of the following discrete transformations: a discrete cosine transform, a discrete sine transform,
determining the watermark embedded in the file to be checked using the coefficient matrices resulting from the transformed data blocks, wherein in each of the coefficient matrices a coefficient modified in dependence on a value of a bit sequence of the watermark assigned to the corresponding coefficient matrices is determined, wherein the respective assigned bit sequence is determined using the corresponding coefficient,
identifying the origin assigned to the file to be checked using the determined watermark.

13. A computer program product comprising a no-transitory computer-readable storage medium having a secured file embodied therein, wherein a watermark identifying an origin assigned to the file as proof of origin is embedded multiple times in redundant form in the secured file using the method of claim 1.

14. A computer program product for securing a file using a digital watermark, wherein the computer program product comprises a non-transitory computer-readable storage medium having machine-readable program instructions embodied therein, wherein execution of the machine-readable program instructions by a processor unit of a computer device causes the computer device to:
receive the file to be secured,
receive the watermark to be embedded in the file to be secured, which is configured as proof of origin of the file to be secured and identifies an origin assigned to the file to be secured, wherein the watermark comprises a plurality of bit sequences,
divide the entire file to be secured into a plurality of data blocks,
transform and group the data blocks into a plurality of groups, wherein the transforming comprises transforming the data blocks, in each case, into a coefficient matrix with a plurality of coefficients of a discrete frequency transformation applied to the corresponding data block, wherein the discrete frequency transformation is one of the following discrete transformations: a discrete cosine transform, a discrete sine transform, wherein a coefficient matrix is assigned to all groups for each bit sequence of the watermark,
embed the watermark in each group of the plurality of groups, wherein in each group of the plurality of groups, a coefficient per assigned coefficient matrix is changed in dependence on a value of the bit sequence of the watermark assigned to the corresponding coefficient matrix,
back-transform the modified coefficient matrices into a modified data block using an inverse discrete frequency transformation applied to the corresponding coefficient matrix,
provide the resulting modified file.

15. A computer device for securing a file using a digital watermark, wherein the computer device comprises a processor unit and a memory unit with machine-readable program instructions, wherein execution of the machine-readable program instructions by the processor unit causes the computer device to:
receive the file to be secured,
receive the watermark to be embedded in the file to be secured, which is configured as proof of origin of the file to be secured and identifies an origin assigned to the file to be secured, wherein the watermark comprises a plurality of bit sequences,
divide the entire file to be secured into a plurality of data blocks,
transform and group the data blocks into a plurality of groups, wherein the transforming comprises transforming the data blocks, in each case, into a coefficient matrix with a plurality of coefficients of a discrete frequency transformation applied to the corresponding data block, wherein the discrete frequency transformation is one of the following discrete transformations: a discrete cosine transform, a discrete sine transform, wherein a coefficient matrix is assigned to each group for each bit sequence of the watermark,
embed the watermark in each group of the plurality of groups, wherein in each group of the plurality of groups, a coefficient per assigned coefficient matrix is changed depending on a value of the bit sequence of the watermark assigned to the corresponding coefficient matrix,
back-transform the modified coefficient matrices into a modified data block using an inverse discrete frequency transformation applied to the corresponding coefficient matrix,
provide the resulting modified file.
